(19) United States
(12) Patent Application Publication
(10) Pub. No.: US 2018/0366280 A1
(43) Pub. Date: Dec. 20, 2018

(54) ELECTRODES AND ELECTROLYTES FOR AQUEOUS ELECTROCHEMICAL ENERGY STORAGE SYSTEMS

(71) Applicant: The Regents of the University of California, Oakland, CA (US)

(72) Inventors: Jee Youn Hwang, Los Angeles, CA (US); Maher F. El-Kady, Los Angeles, CA (US); Richard B. Kaner, Pacific Palisades, CA (US); Jack Kavanaugh, Los Angeles, CA (US)

(73) Assignee: NANOTECH ENERGY, INC, Los Angeles, CA (US)

(21) Appl. No.: 16/004,818

(22) Filed: Jun. 11, 2018

Related U.S. Application Data
(60) Provisional application No. 62/519,225, filed on Jun. 14, 2017.

(51) Int. Cl. H01G 11/36; H01M 8/18; H01M 4/583; H01M 4/52; H01G 11/02; H01G 11/24; H01G 11/46; H01G 11/86; H01G 11/62

(52) U.S. Cl. CPC H01G 11/36; H01M 8/186; H01M 4/583; H01M 4/521; H01G 11/02; H01G 11/28; H01G 11/46; H01G 11/86; H01G 11/62; H01M 2300/0002; H01G 11/24

(57) ABSTRACT

Energy storage devices comprising carbon-based electrodes comprising energy-dense faradaic materials and oxidation-reduction (redox) electrolytes are disclosed. In some embodiments, the carbon-based electrodes comprise energy-dense magnetite nanoparticles. In some embodiments, the redox electrolytes comprise ferricyanide/ferrocyanide redox couple. Also described are processes, methods, protocols, and the like for manufacturing carbon-based electrodes comprising magnetite nanoparticles for use in high energy storage devices such as supercapacitors and for manufacturing high energy storage devices comprising redox electrolytes.

### RELATED APPLICATIONS

This application claims the benefit of provisional patent application Ser. No. 62/519,225, filed Jun. 14, 2017, the disclosure of which is hereby incorporated herein by reference in its entirety.

### BACKGROUND

There is a need for energy storage devices with the capability for storing and discharging energy very quickly and effectively. Some energy storage devices such as supercapacitors feature activated carbon electrodes impregnated with a non-aqueous electrolyte (typically acetonitrile) that operate at voltages between 2.2 V and 2.7 V. Unfortunately, activated carbons may have low specific capacitance in organic electrolytes, which severely limits the energy density of energy storage devices. In addition, organic solvents are often flammable, leading to safety and environmental concerns. Aqueous electrolytes, on the other hand, are safer and cheaper and have higher ionic conductivity, promising higher capacitance electrodes. There is a need for high-performance aqueous energy storage devices, such as batteries, supercapacitors, and micro-supercapacitors.

### SUMMARY

The present disclosure provides aqueous energy storage devices. In some embodiments, the aqueous energy storage devices comprise symmetric supercapacitors operating at ultrahigh voltages of high specific capacitances. In some embodiments, the electrodes and electrolytes of the supercapacitors work synergistically towards improving not only the capacitance of the electrodes but also the voltage and cycling stability of the supercapacitors.

In some embodiments, the aqueous energy storage devices comprise micro-supercapacitors. Also disclosed are methods of fabricating micro-supercapacitors with great potential for miniaturized electronics.

The present disclosure provides an effective strategy for designing and fabricating high-performance aqueous energy devices such as batteries, supercapacitors, and micro-supercapacitors through the rational design of the electrode materials. In some embodiments, the electrodes disclosed herein have been carefully designed so that energy-dense magnetite nanoparticles are hybridized with a three-dimensional form of graphene, resulting in electrodes with a high surface area, a high electronic conductivity, and a high content of energy-dense faradaic materials, which is ideal for energy storage. In some embodiments, the hybrid electrodes have been combined with a functional oxidation-reduction (redox) electrolyte to produce a redox supercapacitor with ultrahigh energy density. The present disclosure provides designs of the positive and the negative electrodes and the utilization of redox electrolytes to increase the voltage window and the charge storage capacity of the energy storage device.

One aspect provided herein is an energy storage device comprising two or more electrodes, wherein at least one electrode comprises a carbonaceous material and a faradaic, capacitive, or pseudo-capacitive material, and a redox-active electrolyte. In some embodiments, the energy storage device is a battery, a supercapacitor, and/or a micro-supercapacitor.

In some embodiments, the carbonaceous material comprises an interconnected corrugated carbon-based network. In some embodiments, the carbonaceous material comprises laser-scribed graphene (LSG).

In some embodiments, the faradaic, capacitive, or pseudo-capacitive material comprises metallic nanoparticles. In some embodiments, the metallic nanoparticles comprise metal oxide particles. In some embodiments, the metal oxide particles comprise magnetite (Fe₃O₄), iron oxide (Fe₂O₃), manganese dioxide (MnO₂), ruthenium dioxide (RuO₂), cobalt oxide (CO₃O₄), nickel hydroxide (Ni(OH)₂), nickel oxide (NiO), copper oxide (CuO), molybdenum trioxide (MoO₃), vanadium pentoxide (V₂O₅), or any combination thereof. In some embodiments, the metal oxide particles comprise magnetite.

In some embodiments, the redox-active electrolyte comprises fluorine, manganese, chlorine, chromium, oxygen, silver, iron, iodine, copper, tin, quinone, bromine, iodine, vanadium, or combinations thereof. In some embodiments, the redox-active electrolyte comprises potassium ferrocyanide, hydroquinone, vanadyl sulfate, p-phenylenediamine, p-phenylenediimine, potassium iodide, potassium bromide, copper chloride, hydroquinone, copper sulfate, heptylviologen dibromide, methyl viologen bromide, or any combination thereof. In some embodiments, the redox-active electrolyte comprises ferric cations. In some embodiments, the redox-active electrolyte comprises Fe(CN)₆³⁻/Fe(CN)₆⁴⁻. In some embodiments, the redox-active electrolyte comprises an aqueous solution. In some embodiments, the aqueous solution comprises sulfate ions. In some embodiments, the aqueous solution comprises sodium ions. In some embodiments, the aqueous solution comprises Na₂SO₄. In some embodiments, the redox-active electrolyte comprises Fe(CN)₆³⁻/Fe(CN)₆⁴⁻ and Na₂SO₄.

In some embodiments, the carbonaceous material comprises LSG; the faradaic, capacitive, or pseudocapacitive material comprises magnetite; and the redox-active electrolyte comprises Fe(CN)₆³⁻/Fe(CN)₆⁴⁻ and Na₂SO₄.

In some embodiments, the at least one electrode comprises a magnetite content of about 20% to about 80%. In some embodiments, the at least one electrode comprises a magnetite content of at least about 20%, about 25%, about 30%, about 35%, about 40%, about 45%, about 50%, about 55%, about 60%, or about 70%. In some embodiments, the at least one electrode comprises a magnetite content of at most about 25%, about 30%, about 35%, about 40%, about 45%, about 50%, about 55%, about 60%, about 70%, or about 80%. In some embodiments, the at least one electrode comprises a magnetite content of about 20% to about 25%, about 20% to about 30%, about 20% to about 35%, about 20% to about 40%, about 20% to about 45%, about 20% to about 50%, about 20% to about 55%, about 20% to about 60%, about 20% to about 70%, about 20% to about 80%, about 25% to about 30%, about 25% to about 35%, about 25% to about 40%, about 25% to about 45%, about 25% to about 50%, about 25% to about 55%, about 25% to about 60%, about 25% to about 70%, about 25% to about 80%, about 30% to about 35%, about 30% to about 40%, about 30% to about 45%, about 30% to about 50%, about 30% to about 55%, about 30% to about 60%, about 30% to about 70%, about 30% to about 80%, about 35% to about 40%, about 35% to about 45%, about 35% to about 50%, about 35% to about 55%, about 35% to about 60%, about 35% to about 70%, about 35% to about 80%, about 40% to about 45%, about 40% to about 50%, about 40% to about 55%, about 40% to about 60%, about 40% to about 70%, about 40% to about 80%, about 45% to about 50%, about 45% to about 55%, about 45% to about 60%, about 45% to about 70%, about 45% to about 80%, about 50% to about 55%, about 50% to about 60%, about 50% to about 70%, about 50% to about 80%, about 55% to about 60%, about 55% to about 70%, about 55% to about 80%, about 60% to about 70%, about 60% to about 80%, or about 70% to about 80%. In some embodiments, the at least one electrode comprises a magnetite content of about 20%, about 25%, about 30%, about 35%, about 40%, about 45%, about 50%, about 55%, about 60%, about 70%, or about 80%.

In some embodiments, the at least one electrode possesses a magnetic moment.

In some embodiments, the energy storage device has an operational voltage of about 0.9 V to about 3 V. In some embodiments, the energy storage device has an operational voltage of at least about 0.9 V about 1 V, about 1.25 V, about 1.5 V, about 1.75 V, about 2 V, about 2.25 V, about 2.5 V, about 2.75 V, or about 3 V. In some embodiments, the energy storage device has an operational voltage of at most about 0.9 V about 1 V, about 1.25 V, about 1.5 V, about 1.75 V, about 2 V, about 2.25 V, about 2.5 V, about 2.75 V, or about 3 V. In some embodiments, the energy storage device has an operational voltage of about 0.9 V to about 1 V, about 0.9 V to about 1.25 V, about 0.9 V to about 1.5 V, about 0.9 V to about 1.75 V, about 0.9 V to about 2 V, about 0.9 V to about 2.25 V, about 0.9 V to about 2.5 V, about 0.9 V to about 2.75 V, about 0.9 V to about 3 V, about 1 V to about 1.25 V, about 1 V to about 1.5 V, about 1 V to about 1.75 V, about 1 V to about 2 V, about 1 V to about 2.25 V, about 1 V to about 2.5 V, about 1 V to about 2.75 V, about 1 V to about 3 V, about 1.25 V to about 1.5 V, about 1.25 V to about 1.75 V, about 1.25 V to about 2 V, about 1.25 V to about 2.25 V, about 1.25 V to about 2.5 V, about 1.25 V to about 2.75 V, about 1.25 V to about 3 V, about 1.5 V to about 1.75 V, about 1.5 V to about 2 V, about 1.5 V to about 2.25 V, about 1.5 V to about 2.5 V, about 1.5 V to about 2.75 V, about 1.5 V to about 3 V, about 1.75 V to about 2 V, about 1.75 V to about 2.25 V, about 1.75 V to about 2.5 V, about 1.75 V to about 2.75 V, about 1.75 V to about 3 V, about 2 V to about 2.25 V, about 2 V to about 2.5 V, about 2 V to about 2.75 V, about 2 V to about 3 V, about 2.25 V to about 2.5 V, about 2.25 V to about 2.75 V, about 2.25 V to about 3 V, about 2.5 V to about 2.75 V, about 2.5 V to about 3 V, or about 2.75 V to about 3 V. In some embodiments, the energy storage device has an operational voltage of about 0.9 V, about 1 V, about 1.25 V, about 1.5 V, about 1.75 V, about 2 V, about 2.25 V, about 2.5 V, about 2.75 V, or about 3 V.

In some embodiments, the energy storage device has a specific capacitance of about 150 farads per gram (F/g) to about 1,400 F/g. In some embodiments, the energy storage device has a specific capacitance of at least about 150 F/g. In some embodiments, the energy storage device has a specific capacitance of at most about 1,400 F/g. In some embodiments, the energy storage device has a specific capacitance of about 150 F/g to about 200 F/g, about 150 F/g to about 300 F/g, about 150 F/g to about 400 F/g, about 150 F/g to about 500 F/g, about 150 F/g to about 600 F/g, about 150 F/g to about 800 F/g, about 150 F/g to about 1,000 F/g, about 150 F/g to about 1,200 F/g, about 150 F/g to about 1,400 F/g, about 200 F/g to about 300 F/g, about 200 F/g to about 400 F/g, about 200 F/g to about 500 F/g, about 200 F/g to about 600 F/g, about 200 F/g to about 800 F/g, about 200 F/g to about 1,000 F/g, about 200 F/g to about 1,200 F/g, about 200 F/g to about 1,400 F/g, about 300 F/g to about 400 F/g, about 300 F/g to about 500 F/g, about 300 F/g to about 600 F/g, about 300 F/g to about 800 F/g, about 300 F/g to about 1,000 F/g, about 300 F/g to about 1,200 F/g, about 300 F/g to about 1,400 F/g, about 400 F/g to about 500 F/g, about 400 F/g to about 600 F/g, about 400 F/g to about 800 F/g, about 400 F/g to about 1,000 F/g, about 400 F/g to about 1,200 F/g, about 400 F/g to about 1,400 F/g, about 500 F/g to about 600 F/g, about 500 F/g to about 800 F/g, about 500 F/g to about 1,000 F/g, about 500 F/g to about 1,200 F/g, about 500 F/g to about 1,400 F/g, about 600 F/g to about 800 F/g, about 600 F/g to about 1,000 F/g, about 600 F/g to about 1,200 F/g, about 600 F/g to about 1,400 F/g, about 800 F/g to about 1,000 F/g, about 800 F/g to about 1,200 F/g, about 800 F/g to about 1,400 F/g, about 1,000 F/g to about 1,200 F/g, about 1,000 F/g to about 1,400 F/g, or about 1,200 F/g to about 1,400 F/g. In some embodiments, the energy storage device has a specific capacitance of about 150 F/g, about 200 F/g, about 300 F/g, about 400 F/g, about 500 F/g, about 600 F/g, about 800 F/g, about 1,000 F/g, about 1,200 F/g, or about 1,400 F/g.

In some embodiments, the energy storage device has an energy density of about 45 watt-hours per kilogram (Wh/kg) to about 250 Wh/kg. In some embodiments, the energy storage device has an energy density of at least about 45 Wh/kg, about 50 Wh/kg, about 75 Wh/kg, about 100 Wh/kg, about 125 Wh/kg, about 150 Wh/kg, about 175 Wh/kg, about 200 Wh/kg, about 225 Wh/kg, or about 250 Wh/kg. In some embodiments, the energy storage device has an energy density of at most about 45 Wh/kg, about 50 Wh/kg, about 75 Wh/kg, about 100 Wh/kg, about 125 Wh/kg, about 150 Wh/kg, about 175 Wh/kg, about 200 Wh/kg, about 225 Wh/kg, or about 250 Wh/kg. In some embodiments, the energy storage device has an energy density of about 45 Wh/kg to about 50 Wh/kg, about 45 Wh/kg to about 75 Wh/kg, about 45 Wh/kg to about 100 Wh/kg, about 45 Wh/kg to about 125 Wh/kg, about 45 Wh/kg to about 150 Wh/kg, about 45 Wh/kg to about 175 Wh/kg, about 45 Wh/kg to about 200 Wh/kg, about 45 Wh/kg to about 225 Wh/kg, about 45 Wh/kg to about 250 Wh/kg, about 50 Wh/kg to about 75 Wh/kg, about 50 Wh/kg to about 100 Wh/kg, about 50 Wh/kg to about 125 Wh/kg, about 50 Wh/kg to about 150 Wh/kg, about 50 Wh/kg to about 175 Wh/kg, about 50 Wh/kg to about 200 Wh/kg, about 50 Wh/kg to about 225 Wh/kg, about 50 Wh/kg to about 250 Wh/kg, about 75 Wh/kg to about 100 Wh/kg, about 75 Wh/kg to about 125 Wh/kg, about 75 Wh/kg to about 150 Wh/kg, about 75 Wh/kg to about 175 Wh/kg, about 75 Wh/kg to about 200 Wh/kg, about 75 Wh/kg to about 225 Wh/kg, about 75 Wh/kg to about 250 Wh/kg, about 100 Wh/kg to about 125 Wh/kg, about 100 Wh/kg to about 150 Wh/kg, about 100 Wh/kg to about 175 Wh/kg, about 100 Wh/kg to about 200 Wh/kg, about 100 Wh/kg to about 225 Wh/kg, about 100 Wh/kg to about 250 Wh/kg, about 125 Wh/kg to about 150 Wh/kg, about 125 Wh/kg to about 175 Wh/kg, about 125 Wh/kg to about 200 Wh/kg, about 125 Wh/kg to about 225 Wh/kg, about 125 Wh/kg to about 250 Wh/kg, about 150 Wh/kg to about 175 Wh/kg, about 150 Wh/kg to about 200 Wh/kg, about 150 Wh/kg to about 225 Wh/kg, about 150 Wh/kg to about 250 Wh/kg, about 175 Wh/kg to about 200 Wh/kg, about 175 Wh/kg to about 225 Wh/kg, about 175 Wh/kg to about 250 Wh/kg, about 200 Wh/kg to about 225 Wh/kg, about 200 Wh/kg to about 250 Wh/kg, or about 225 Wh/kg to about 250 Wh/kg. In some embodiments, the energy storage device has an energy density of about 45 Wh/kg, about 50 Wh/kg, about 75 Wh/kg, about 100 Wh/kg, about 125 Wh/kg, about 150 Wh/kg, about 175 Wh/kg, about 200 Wh/kg, about 225 Wh/kg, or about 250 Wh/kg.

In some embodiments, the energy storage device has a power density of about 45 watts per kilogram (W/kg) to about 200 W/kg. In some embodiments, the energy storage device has a power density of at least about 45 W/kg, about 50 W/kg, about 75 W/kg, about 100 W/kg, about 125 W/kg, about 150 W/kg, about 175 W/kg, or about 200 W/kg. In some embodiments, the energy storage device has a power density of at most about 45 W/kg, about 50 W/kg, about 75 W/kg, about 100 W/kg, about 125 W/kg, about 150 W/kg, about 175 W/kg, or about 200 W/kg. In some embodiments, the energy storage device has a power density of about 45 W/kg to about 50 W/kg, about 45 W/kg to about 75 W/kg, about 45 W/kg to about 100 W/kg, about 45 W/kg to about 125 W/kg, about 45 W/kg to about 150 W/kg, about 45 W/kg to about 175 W/kg, about 45 W/kg to about 200 W/kg, about 50 W/kg to about 75 W/kg, about 50 W/kg to about 100 W/kg, about 50 W/kg to about 125 W/kg, about 50 W/kg to about 150 W/kg, about 50 W/kg to about 175 W/kg, about 50 W/kg to about 200 W/kg, about 75 W/kg to about 100 W/kg, about 75 W/kg to about 125 W/kg, about 75 W/kg to about 150 W/kg, about 75 W/kg to about 175 W/kg, about 75 W/kg to about 200 W/kg, about 100 W/kg to about 125 W/kg, about 100 W/kg to about 150 W/kg, about 100 W/kg to about 175 W/kg, about 100 W/kg to about 200 W/kg, about 125 W/kg to about 150 W/kg, about 125 W/kg to about 175 W/kg, about 125 W/kg to about 200 W/kg, about 150 W/kg to about 175 W/kg, about 150 W/kg to about 200 W/kg, or about 175 W/kg to about 200 W/kg. In some embodiments, the energy storage device has a power density of about 45 W/kg, about 50 W/kg, about 75 W/kg, about 100 W/kg, about 125 W/kg, about 150 W/kg, about 175 W/kg, or about 200 W/kg. In some embodiments, the energy storage device has a power density of about 93 Wh/kg.

In some embodiments, the energy storage device has a specific capacitance of about 1489 F g⁻¹ (570 mF cm⁻²) at 8 milliamperes per square centimeter (mA cm⁻²). In some embodiments, the energy storage device has a specific capacitance of about 25.6 farad per cubic centimeter (F cm⁻³; 716 F g⁻¹ electrode) at a scan rate of 20 mV s⁻¹. In some embodiments, the energy storage device has a specific capacitance of about 19.2 F cm⁻³ (535 F g⁻¹ electrode) at a high scan rate of 300 mV s⁻¹.

In some embodiments, the energy storage device comprises at least one electrode comprising LSG and magnetite. In further embodiments, the energy storage device has a specific capacitance of about 114 F/g, about 87.2 mF/cm², and/or about 12.0 F/cm³, at a scan rate of 20 mV/s. In further embodiments, the energy storage device has an energy density of about 72.5 Wh/kg and/or about 0.00765 Wh/cm³, at a scan rate of 20 mV/s. In further embodiments, the energy storage device has a power density of 39.6 kilowatts per kilogram (kW/kg) and/or 4.18 W/cm³, at a scan rate of 300 mV/s.

In some embodiments, the energy storage device comprises at least one electrode comprising LSG and magnetite and a redox-active electrolyte. In further embodiments, the energy storage device has a specific capacitance of about 178.9 F/g, about 186.1 mF/cm², and/or about 25.6 F/cm³, at a scan rate of 20 mV/s. In further embodiments, the energy storage device has an energy density of about 121.5 Wh/kg and/or about 0.0174 Wh/cm³, at a scan rate of 20 mV/s. In further embodiments, the energy storage device has a power density of 55.9 kW/kg and/or 8.03 W/cm³, at a scan rate of 300 mV/s.

In some embodiments, the energy storage device comprises at least one electrode comprising LSG and magnetite and a redox-active electrolyte. In further embodiments, the energy storage device has a specific capacitance of about 178.9 F/g, about 186.1 mF/cm², and/or about 25.6 F/cm³, at a scan rate of 20 mV/s. In further embodiments, the energy storage device has an energy density of about 121.5 Wh/kg and/or about 0.0174 Wh/cm³, at a scan rate of 20 mV/s. In further embodiments, the energy storage device has a power density of 55.9 kW/kg and/or 8.03 W/cm³, at a scan rate of 300 mV/s.

In some embodiments, the energy storage device comprises at least one electrode comprising LSG and magnetite and a redox-active electrolyte. In further embodiments, the energy storage device has a specific capacitance of about 178.9 F/g, about 186.1 mF/cm² and/or about 25.6 F/cm³, at a scan rate of 20 mV/s. In further embodiments, the energy storage device has an energy density of about 121.5 Wh/kg and/or about 0.0174 Wh/cm³, at a scan rate of 20 mV/s. In further embodiments, the energy storage device has a power density of 55.9 kW/kg and/or 8.03 W/cm³, at a scan rate of 300 mV/s.

In one aspect, the disclosure provides herein an electrode comprising a carbonaceous material and metallic nanoparticles. In some embodiments, the carbonaceous material comprises an interconnected corrugated carbon-based network, LSG, a cellular graphene film, a holey graphene framework, a three-dimensional graphene framework, a solvated graphene framework, or any combination thereof.

In some embodiments, the carbonaceous material comprises LSG and the metallic nanoparticles comprise magnetite.

In some embodiments, the metallic nanoparticles comprise magnetite (Fe₃O₄), iron oxide (Fe₂O₃), manganese dioxide (MnO₂), ruthenium dioxide (RuO₂), cobalt oxide (CO₃O₄), nickel hydroxide (Ni(OH)₂), nickel oxide (NiO), copper oxide (CuO), molybdenum trioxide (MoO₃), vanadium pentoxide (V₂O₅), or any combination thereof. In some embodiments, the electrode comprises LSG and magnetite.

In some embodiments, the electrode comprises a magnetite content of about 40% to about 85%. In some embodiments, the electrode comprises a magnetite content of at least 40%, about 45%, about 50%, about 55%, about 60%, about 65%, about 70%, about 75%, about 80%, or about 85%. In some embodiments, the electrode comprises a magnetite content of at most 40%, about 45%, about 50%, about 55%, about 60%, about 65%, about 70%, about 75%, about 80%, or about 85%. In some embodiments, the electrode comprises a magnetite content of about 40% to about 45%, about 40% to about 50%, about 40% to about 55%, about 40% to about 60%, about 40% to about 65%, about 40% to about 70%, about 40% to about 75%, about 40% to about 80%, about 40% to about 85%, about 45% to about 50%, about 45% to about 55%, about 45% to about 60%, about 45% to about 65%, about 45% to about 70%, about 45% to about 75%, about 45% to about 80%, about 45% to about 85%, about 50% to about 55%, about 50% to about 60%, about 50% to about 65%, about 50% to about 70%, about 50% to about 75%, about 50% to about 80%, about 50% to about 85%, about 55% to about 60%, about 55% to about 65%, about 55% to about 70%, about 55% to about 75%, about 55% to about 80%, about 55% to about 85%, about 60% to about 65%, about 60% to about 70%, about 60% to about 75%, about 60% to about 80%, about 60% to about 85%, about 65% to about 70%, about 65% to about 75%, about 65% to about 80%, about 65% to about 85%, about 70% to about 75%, about 70% to about 80%, about 70% to about 85%, about 75% to about 80%, about 75% to about 85%, or about 80% to about 85%. In some embodiments, the electrode comprises a magnetite content of about 40%, about 45%, about 50%, about 55%, about 60%, about 65%, about 70%, about 75%, about 80%, or about 85%.

In some embodiments, the electrode has an areal specific capacitance in a negative voltage window of about 264 millifarads per square centimeter (mF cm⁻²; about 691 farads per gram [F g⁻¹]) at a scan rate of about 20 millivolts per second (mV s⁻¹). In some embodiments, the electrode has an areal specific capacitance in a positive voltage window of about 137 mF cm⁻² (about 357 F g⁻¹) at a scan rate of about 20 mV s⁻¹.

The areal specific capacitances of the LSG/Fe₃O₄ electrode in the negative and positive voltage windows are about 264 mF cm⁻² (about 691 F g⁻¹) and about 137 mF cm⁻² (about 357 F g⁻¹) at a scan rate of about 20 mV s⁻¹, respectively.

Another aspect provided herein is a method of fabricating an electrode comprising sonicating a solution comprising a carbon-based oxide and a metallic salt; disposing the solution comprising a carbon-based oxide and a metallic salt onto a substrate; drying the substrate to create a dried film comprising a carbon-based oxide and a metallic salt; and exposing a portion of the dried film to light to reduce the carbon-based oxide and oxidize the metallic salt. In some embodiments, the carbon-based oxide is graphene oxide. In some embodiments, the metallic salt comprises iron (Fe). In some embodiments, the metallic salt comprises iron chloride (FeCl₃).

In some embodiments, the carbon-based oxide is graphene oxide. In some embodiments, the concentration of the graphene oxide is about 1 gram per liter (g/L) to about 5 g/L. In some embodiments, the concentration of the graphene oxide is at least about 1 g/L. In some embodiments, the concentration of the graphene oxide is at most about 5 g/L. In some embodiments, the concentration of the graphene oxide is about 1 g/L to about 1.5 g/L, about 1 g/L to about 2 g/L, about 1 g/L to about 2.5 g/L, about 1 g/L to about 3 g/L, about 1 g/L to about 3.5 g/L, about 1 g/L to about 4 g/L, about 1 g/L to about 4.5 g/L, about 1 g/L to about 5 g/L, about 1.5 g/L to about 2 g/L, about 1.5 g/L to about 2.5 g/L, about 1.5 g/L to about 3 g/L, about 1.5 g/L to about 3.5 g/L, about 1.5 g/L to about 4 g/L, about 1.5 g/L to about 4.5 g/L, about 1.5 g/L to about 5 g/L, about 2 g/L to about 2.5 g/L, about 2 g/L to about 3 g/L, about 2 g/L to about 3.5 g/L, about 2 g/L to about 4 g/L, about 2 g/L to about 4.5 g/L, about 2 g/L to about 5 g/L, about 2.5 g/L to about 3 g/L, about 2.5 g/L to about 3.5 g/L, about 2.5 g/L to about 4 g/L, about 2.5 g/L to about 4.5 g/L, about 2.5 g/L to about 5 g/L, about 3 g/L to about 3.5 g/L, about 3 g/L to about 4 g/L, about 3 g/L to about 4.5 g/L, about 3 g/L to about 5 g/L, about 3.5 g/L to about 4 g/L, about 3.5 g/L to about 4.5 g/L, about 3.5 g/L to about 5 g/L, about 4 g/L to about 4.5 g/L, about 4 g/L to about 5 g/L, or about 4.5 g/L to about 5 g/L.

In some embodiments, the metallic salt comprises iron (Fe). In some embodiments, the metallic salt comprises iron chloride, ammonium iron(II) sulfate hexahydrate, dichlorotetrakis(pyridine)iron, iron(II) bromide, iron(II) chloride, iron(II) chloride tetrahydrate, iron(II) fluoride, iron(II) molybdate, iron(II) oxalate dihydrate, iron(II) perchlorate hydrate, iron(II) sulfate hydrate, iron(II) tetrafluoroborate hexahydrate, iron(III) bromide, iron(III) fluoride, iron(III) nitrate nonahydrate, iron(III) oxalate hexahydrate, iron(III) phosphate tetrahydrate, iron(III) pyrophosphate soluble crystals, iron(III) sulfate hydrate, potassium hexacyanoferrate(II) trihydrate, or any combination thereof. In some embodiments, the metallic salt comprises iron chloride (FeCl₃).

In some embodiments, the substrate comprises gold-sputtered polyimide. In some embodiments, the substrate comprises aluminum, nickel, copper, platinum, steel, or combinations thereof. In some embodiments, the substrate comprises a carbon substrate. In some embodiments, the substrate is graphite.

In some embodiments, the drying of the substrate occurs at a temperature of about 20° C. to about 100° C. In some embodiments, the drying of the substrate occurs at a temperature of at least about 20° C. In some embodiments, the drying of the substrate occurs at a temperature of at most about 100° C. In some embodiments, the drying of the substrate occurs at a temperature of about 20° C. to about 30° C., about 20° C. to about 40° C., about 20° C. to about 50° C., about 20° C. to about 60° C., about 20° C. to about 70° C., about 20° C. to about 80° C., about 20° C. to about 90° C., about 20° C. to about 100° C., about 30° C. to about 40° C., about 30° C. to about 50° C., about 30° C. to about 60° C., about 30° C. to about 70° C., about 30° C. to about 80° C., about 30° C. to about 90° C., about 30° C. to about 100° C., about 40° C. to about 50° C., about 40° C. to about 60° C., about 40° C. to about 70° C., about 40° C. to about 80° C., about 40° C. to about 90° C., about 40° C. to about 100° C., about 50° C. to about 60° C., about 50° C. to about 70° C., about 50° C. to about 80° C., about 50° C. to about 90° C., about 50° C. to about 100° C., about 60° C. to about 70° C., about 60° C. to about 80° C., about 60° C. to about 90° C., about 60° C. to about 100° C., about 70° C. to about 80° C., about 70° C. to about 90° C., about 70° C. to about 100° C., about 80° C. to about 90° C., about 80° C. to about 100° C., or about 90° C. to about 100° C.

In some embodiments, the light has a wavelength of about 0.01 micrometer (μm) to about 100 μm. In some embodiments, the light has a wavelength of at least about 0.01 μm. In some embodiments, the light has a wavelength of at most about 100 μm. In some embodiments, the light has a wavelength of about 0.01 μm to about 0.05 μm, about 0.01 μm to about 0.1 μm, about 0.01 μm to about 0.5 μm, about 0.01 μm to about 1 μm, about 0.01 μm to about 10 μm, about 0.01 μm to about 50 μm, about 0.01 μm to about 100 μm, about 0.05 μm to about 0.1 μm, about 0.05 μm to about 0.5 μm, about 0.05 μm to about 1 μm, about 0.05 μm to about 10 μm, about 0.05 μm to about 50 μm, about 0.05 μm to about 100 μm, about 0.1 μm to about 0.5 μm, about 0.1 μm to about 1 μm, about 0.1 μm to about 10 μm, about 0.1 μm to about 50 μm, about 0.1 μm to about 100 μm, about 0.5 μm to about 1 μm, about 0.5 μm to about 10 μm, about 0.5 μm to about 50 μm, about 0.5 μm to about 100 μm, about 1 μm to about 10 μm, about 1 μm to about 50 μm, about 1 μm to about 100 μm, about 10 μm to about 50 μm, about 10 μm to about 100 μm, or about 50 μm to about 100 μm.

In some embodiments, the light is emitted from a laser. In further embodiments, the laser is a 7 watt (W) carbon dioxide (CO₂) laser.

In some embodiments, the method of fabricating further comprises washing the dried film with deionized water.

In some embodiments, the energy storage device is a battery, a supercapacitor, and/or a micro-supercapacitor.

In another aspect, the disclosure provides methods of fabricating micro-structured electrodes using methods of fabricating electrodes described herein. In some embodiments, the methods of fabricating the micro-structured electrode comprise sonicating a solution comprising a carbon-based oxide and a metallic salt; disposing the solution comprising a carbon-based oxide and a metallic salt onto a substrate; drying the substrate to create a dried film comprising a carbon-based oxide and a metallic salt; exposing a portion of the dried film to light to reduce the carbon-based oxide and oxidize the metallic salt; washing the dried film with deionized water; and patterning the substrate with the dried film with light.

In some embodiments, the patterning comprises creating a six interdigitated electrode pattern. In some embodiments, the patterning comprises using light emitted from a laser. In some embodiments, the laser is a 24 W CO₂ laser.

### BRIEF DESCRIPTION OF THE DRAWINGS

The features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings or figures (also “FIG.” and “FIGs.” herein), of which:

FIG. 1 shows a schematic illustration of an exemplary method for laser-scribed graphene (LSG)/Fe₃O₄ nanocomposite electrodes, in accordance with some embodiments.

FIG. 2A shows thermo-gravimetric analysis (TGA) and a differential thermal analysis (DTA) measurements of the deoxygenation of graphene oxide (GO), in accordance with some embodiments.

FIG. 2B shows TGA and DTA measurements of the formation of iron oxide from the FeCl₃.

FIG. 2C shows TGA and DTA measurements of the spontaneous, simultaneous reduction of GO to reduced GO (r-GO) and the oxidation of FeCl₃ to iron oxide.

FIG. 3A shows a scanning electron microscope (SEM) image of exemplary Fe₃O₄ nanoparticles grown on LSG, in accordance with some embodiments.

FIG. 3B shows a high-magnification SEM image of an exemplary LSG/Fe₃O₄ nanocomposite, in accordance with some embodiments.

FIG. 3C shows a transverse electromagnetic (TEM) image of the exemplary LSG/Fe₃O₄ nanocomposite of FIG. 3B, in accordance with some embodiments.

FIG. 3D shows a high-resolution TEM image of a selected electron area diffraction pattern of an exemplary Fe₃O₄ in the LSG composite, in accordance with some embodiments.

FIG. 3E shows an X-ray diffraction pattern of the exemplary LSG/Fe₃O₄ nanocomposite of FIG. 3B, in accordance with some embodiments.

FIG. 3F shows a photograph of an exemplary LSG/Fe₃O₄ nanocomposite dispersed in an aqueous solution without and with an external magnetic field, in accordance with some embodiments.

FIG. 4A shows a cross-sectional SEM image of an exemplary LSG/Fe₃O₄ film on a plastic substrate, in accordance with some embodiments.

FIG. 4B shows an exemplary high-resolution TEM image of the d-spacing of an exemplary Fe₃O₄ electrode, in accordance with some embodiments.

FIG. 5 shows a TGA of an exemplary LSG/Fe₃O₄ nanocomposite, in accordance with some embodiments.

FIG. 6A shows cyclic voltammetry (CV) curves of an exemplary LSG supercapacitor and an exemplary LSG/Fe₃O₄ supercapacitor at 50 millivolts per second (mV s⁻¹), in accordance with some embodiments.

FIG. 6B shows CV curves of the exemplary LSG supercapacitor and an exemplary LSG/Fe₃O₄ supercapacitor of FIG. 6A at 70 mV s⁻¹, in accordance with some embodiments.

FIG. 7A shows CV curves of the negative voltage window (0 V to −1.0 V vs. Ag/AgCl) of an exemplary three LSG/Fe₃O₄ electrode device in 1.0 M Na₂SO₄ at different scan rates of 10, 20, 30, 50, 70, and 100 mV s⁻¹.

FIG. 7B shows the same CV curves of the positive voltage window (0 V to 0.8 V vs. Ag/AgCl) of the device of FIG. 7A at different scan rates of 10, 20, 30, 50, 70, and 100 mV s⁻¹.

FIG. 7C shows charge-discharge (CC) curves of the negative voltage window (0 V to −1.0 V vs. Ag/AgCl) of an exemplary LSG/Fe₃O₄ electrode at different current densities.

FIG. 7D shows the same CC curves of the positive voltage window (0 V to 0.8 V vs. Ag/AgCl) of an exemplary LSG/Fe₃O₄ electrode at different current densities.

FIG. 8A shows an exemplary LSG/Fe₃O₄ supercapacitors using 1.0 M Na₂SO₄ electrolyte in the absence of a redox additive, and in the presence of a redox additive, in accordance with some embodiments.

FIG. 8B shows CV curves of the exemplary LSG/Fe₃O₄ supercapacitor of FIG. 8A at various redox additive concentrations, at a scan rate of 50 mV s⁻¹, in accordance with some embodiments.

FIG. 8C shows CC curves of the exemplary LSG/Fe₃O₄ supercapacitor of FIG. 8A at various redox additive concentrations, at a current density of 8 mA cm⁻², in accordance with some embodiments.

FIG. 8D shows the specific capacitance by area and active material mass vs. current density for an exemplary LSG/Fe₃O₄ electrode in 1.0 M Na₂SO₄ and different concentrations of the redox additive, measured in a three-electrode setup, in accordance with some embodiments.

FIG. 8E shows CV curves at 20 mV s⁻¹ for an LSG/Fe₃O₄ electrode tested at different potential regions, in accordance with some embodiments.

FIG. 8F shows the areal capacitance and electric charge at a 10 mV s⁻¹ scan rate for the negative and positive electrodes in the absence and presence of a 0.025 M redox additive.

FIG. 8G shows CV curves of an exemplary symmetric supercapacitor comprising LSG/Fe₃O₄ electrodes at a scan rate of 50 mV s⁻¹, in accordance with some embodiments.

FIG. 8H shows CC curves of an exemplary symmetric supercapacitor comprising LSG/Fe₃O₄ electrodes at a current density of 12 mA cm⁻², in accordance with some embodiments.

FIG. 8I shows areal capacitance and stack capacitance of an exemplary symmetric supercapacitor comprising LSG/Fe₃O₄ electrodes as a function of the applied current density in the absence and in the presence of a 0.025 M redox additive, in accordance with some embodiments.

FIG. 9A shows galvanostatic CC curves at a current density of 4 milliamperes per square centimeter (mA cm⁻²) of the exemplary LSG supercapacitor and an exemplary LSG/Fe₃O₄ supercapacitor of FIG. 6A at an increasing voltage window from 1.0 V to 1.8 V, in accordance with some embodiments.

FIG. 9B shows CV curves of an exemplary LSG and an exemplary LSG/Fe₃O₄ supercapacitor at 100 mV s⁻¹, in accordance with some embodiments.

FIG. 10A shows the CV curves of an exemplary symmetric LSG supercapacitor measured to 1.8 V with 1.0 M Na₂SO₄ aqueous electrolyte at a scan rate of 100 mV s⁻¹.

FIG. 10B shows the CV curves of an exemplary Fe₃O₄ supercapacitor measured to 1.8 V with 1.0 M Na₂SO₄ aqueous electrolyte at a scan rate of 100 mV s⁻¹.

FIG. 11A shows CV curves of an exemplary LSG/Fe₃O₄ supercapacitor at scan rates of 10, 20, 30, 50, 70, and 100 mV s⁻¹, in accordance with some embodiments.

FIG. 11B shows CV curves of an exemplary LSG/Fe₃O₄ supercapacitor at scan rates of 200, 300, 500, 700, and 1000 mV s⁻¹, at a maximum voltage of 1.8 V, in accordance with some embodiments.

FIG. 12A shows CV curves of an exemplary symmetric LSG/Fe₃O₄ supercapacitor at scan rates of 1.5, 2.0, 5.0, 7.0, and 10 V s⁻¹.

FIG. 12B shows CC curves of the exemplary symmetric LSG/Fe₃O₄ supercapacitor of FIG. 12A at current densities of 4, 8, 12, 16, and 20 mA cm⁻².

FIG. 12C shows CC curves of the exemplary symmetric LSG/Fe₃O₄ supercapacitor of FIG. 12A at current densities of 40, 60, 80, 100, and 120 mA cm⁻².

FIG. 12D shows CC curves of the exemplary symmetric LSG/Fe₃O₄ supercapacitor of FIG. 12A at current densities of 160, 240, 320 and 400 mA cm⁻².

FIG. 12E shows the active material mass specific capacitance of an exemplary electrode in an exemplary symmetric LSG/Fe₃O₄ supercapacitor vs. current density.

FIG. 12F shows the active material mass specific capacitance of an exemplary electrode in an exemplary symmetric LSG/Fe₃O₄ supercapacitor vs. scan rate.

FIG. 13A shows a Nyquist plot with a magnified high-frequency region of an exemplary LSG/Fe₃O₄ symmetric supercapacitor over a frequency range from 1 MHz to 0.01 Hz, in accordance with some embodiments.

FIG. 13B shows Bode plots of an exemplary LSG/Fe₃O₄ symmetric supercapacitor over a frequency range from 1 MHz to 0.01 Hz, in accordance with some embodiments.

FIG. 13C shows CV curves of an exemplary flexible LSG/Fe₃O₄ full cell at different bending radii and at a scan rate of 100 mV s⁻¹, in accordance with some embodiments.

FIG. 14 shows exemplary CV curves of an LSG/Fe₃O₄ electrode with 1.0 M Na₂SO₄ electrolyte and 1.0 M Na₂SO₄+0.005 M [Fe(CN)₆³⁻/Fe(CN)₆⁴⁻] redox-active electrolyte, in accordance with some embodiments.

FIG. 15 provides a Nyquist plot of the electrochemical impedance spectrum of an exemplary LSG/Fe₃O₄ electrode, with various concentrations of [Fe(CN)₆³⁻/Fe(CN)₆⁴⁻] redox-active electrolyte in 1.0 M Na₂SO₄ electrolyte, in accordance with some embodiments.

FIG. 16A shows CC curves of an exemplary symmetric LSG/Fe₃O₄ supercapacitor with various concentrations of the [Fe(CN)₆³⁻/Fe(CN)₆⁴⁻] redox-active electrolyte in 1.0 M Na₂SO₄ electrolyte at 12 mA cm⁻², in accordance with some embodiments.

FIG. 16B shows CV curves of an exemplary symmetric LSG/Fe₃O₄ supercapacitor with various concentrations of the [Fe(CN)₆³⁻/Fe(CN)₆⁴⁻] redox-active electrolyte at 50 mV s⁻¹, in accordance with some embodiments.

FIG. 16C shows the areal capacitance and coulombic efficiency at different concentrations of redox-active electrolyte as listed, based on the CC results, in accordance with some embodiments.

FIG. 17A shows CV curves of an exemplary symmetric LSG/Fe₃O₄ supercapacitor with 0.025 M redox-active electrolyte (RE) at different scan rates of 20 to 100 mV s⁻¹, in accordance with some embodiments.

FIG. 17B shows CV curves of an exemplary symmetric LSG/Fe₃O₄ supercapacitor with 0.025 M RE at different scan rates of 200 to 1000 mV s⁻¹, in accordance with some embodiments.

FIG. 17C shows CC curves of an exemplary symmetric LSG/Fe₃O₄ supercapacitor with 0.025 M RE at current densities of 12, 20, and 32 mA cm⁻², in accordance with some embodiments.

FIG. 17D shows the CC curves of an exemplary symmetric LSG/Fe₃O₄ supercapacitor with 0.025 M RE at current densities of 40, 48, 60, and 80 mA cm⁻², in accordance with some embodiments.

FIG. 18A shows self-discharge curves of an exemplary LSG/Fe₃O₄ supercapacitor with [Fe(CN)₆³⁻/Fe(CN)₆⁴⁻] redox-active electrolyte, in accordance with some embodiments.

FIG. 18B shows leakage current measurements of an exemplary LSG/Fe₃O₄ supercapacitor with [Fe(CN)₆³⁻/Fe(CN)₆⁴⁻] redox-active electrolyte, in accordance with some embodiments.

FIG. 19A shows an exemplary schematic illustration of a microfabrication process of forming a LSG/Fe₃O₄ hybrid micro-supercapacitor via laser irradiation, in accordance with some embodiments.

FIG. 19B shows a photograph of an exemplary micro-supercapacitor with the interdigitated pattern, in accordance with some embodiments.

FIG. 19C shows CV curves of an exemplary symmetric LSG/Fe₃O₄ micro-supercapacitor at a scan rate 100 mV s⁻¹, in accordance with some embodiments.

FIG. 20A shows CC curves for an exemplary LSG/Fe₃O₄ micro-supercapacitor with and without a redox electrolyte, at a current density of 4.8 mA cm⁻², in accordance with some embodiments.

FIG. 20B shows CC curves at different current densities for an exemplary LSG/Fe₃O₄ micro-supercapacitor with a 1.0 M Na₂SO₄ and 0.025 M RE electrolyte, in accordance with some embodiments.

FIG. 20C shows CV curves at different scan rates for an exemplary LSG/Fe₃O₄ micro-supercapacitor with a 1.0 M Na₂SO₄ and 0.025 M RE electrolyte, in accordance with some embodiments.

FIG. 21A shows a photograph of an exemplary micro-supercapacitor module with two cells connected in series that were made in a single step, in accordance with some embodiments.

FIG. 21B shows CV curves of an exemplary LSG/Fe₃O₄ hybrid micro-supercapacitor, in accordance with some embodiments.

FIG. 21C shows CC curves of two exemplary micro-supercapacitors connected in series, in accordance with some embodiments.

FIG. 22A shows the potential range and specific capacitances of exemplary symmetric LSG/Fe₃O₄ supercapacitors without (SC) and with a redox additive (SC-RE), in accordance with some embodiments.

FIG. 22B shows a Ragone plot of the gravimetric energy density and power density of exemplary SC, SC-RE and a micro-supercapacitor (MSC-RE), in accordance with some embodiments.

FIG. 22C shows a Ragone plot comparing the volumetric energy density and power density of the exemplary supercapacitors with exemplary commercially available energy storage devices, in accordance with some embodiments.

FIG. 22D shows the cycling stability of an exemplary LSG/Fe₃O₄ supercapacitor with and without a redox-additive at 1.0 V and 1.8 V voltage windows, in accordance with some embodiments.

FIG. 22E shows photographs demonstrating that two exemplary tandem symmetric LSG/Fe₃O₄ supercapacitors connected in series can power light-emitting diodes of different colors, in accordance with some embodiments.

FIG. 23A shows an exemplary schematic cross-section illustration of an exemplary sandwich-type supercapacitor, in accordance with some embodiments.

FIG. 23B shows an exemplary schematic cross-section illustration of interdigitated micro-supercapacitor, in accordance with some embodiments.

### DETAILED DESCRIPTION

Provided herein are methods, devices, and devices for designing and fabricating electrodes comprising energy-dense faradaic materials and high-performance energy storage devices.

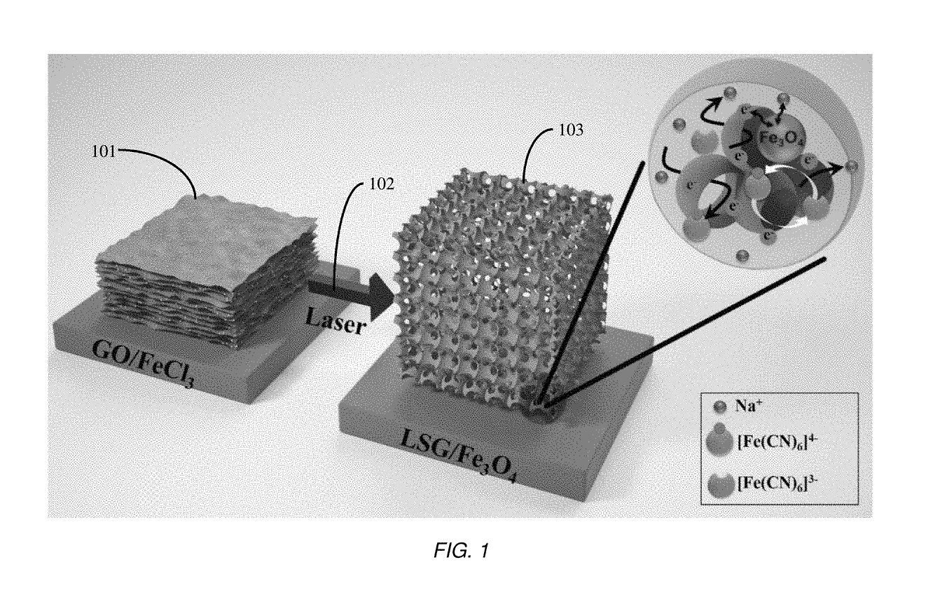

FIG. 1 shows a schematic illustration of an exemplary method for laser-scribed graphene (LSG)/Fe₃O₄ nanocomposite electrodes, in accordance with some embodiments. As seen the exemplary method comprises exposing a graphene oxide (GO)/FeCl₃ film 101 to a laser 102 to create an electrode 103 of LSG wrapped with Fe₃O₄ nanoparticles. In some embodiments, the laser is a 7 W CO₂ laser. This photothermal process is extremely fast and tunable to produce electrodes with a wide array of shapes and capacities.

Graphene oxide may be synthesized from graphite flakes using a modified Hummers' method whereby FeCl₃.6H₂O in a powder form is slowly added to a GO dispersion in water. In some embodiments the FeCl₃.6H₂O powder is added to a GO dispersion in water under continuous stirring. Some embodiments further comprise sonication. In some embodiments the sonication is performed for about 30 minutes.

In some embodiments the solution is then drop-cast onto a sheet. The sheet may comprise a gold-sputtered polyimide sheet. In some cases, the solution-covered sheet is dried and exposed to a laser to synthesize the LSG/Fe₃O₄ film. In some embodiments the solution-covered sheet is dried for about 12 hours. In some embodiments the solution-covered sheet is dried under ambient conditions. In some embodiments the laser comprises a 7 W CO₂ laser. An exemplary 7 W CO₂ laser employable for the methods herein is a Full Spectrum Laser H-series. The LSG/Fe₃O₄ film may then be washed with deionized water and directly used as a supercapacitor electrode. The electrodes, the active material (LSG/Fe₃O₄), and the current collector may then be patterned to form an interdigitated electrode. Patterning may be performed using a 24-W CO₂ laser. An exemplary 24-W CO₂ patterning laser for the methods herein is a Full Spectrum Laser H-series laser.

The resulting LSG/Fe₃O₄ can be used in combination with a redox-active electrolyte containing a [Fe(CN)₆³⁻/Fe(CN)₆⁴⁻] redox couple to form a supercapacitor device configured to store charge both through reversible redox reactions on the electrode side (pseudo-capacitive Fe₃O₄ nanoparticles) and the electrolyte side (redox additive).

Chemical Reactions During LSG/Fe₃O₄ Synthesis

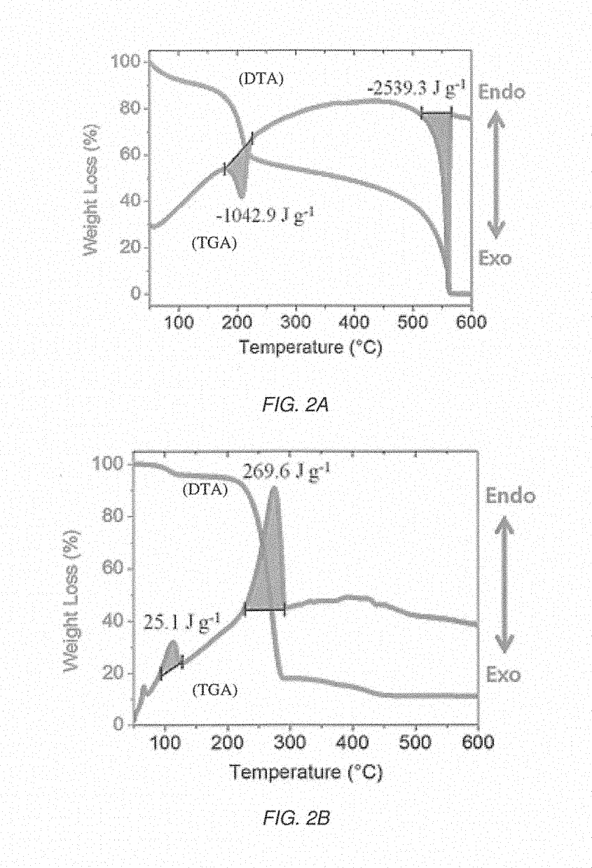

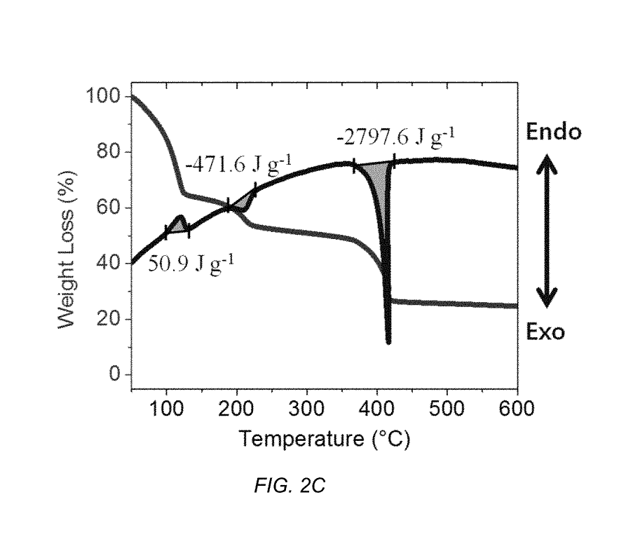

FIG. 2A shows thermo-gravimetric analysis (TGA) and differential thermal analysis (DTA) measurements of the deoxygenation of GO, in accordance with some embodiments. FIG. 2B shows TGA and DTA measurements of the formation of iron oxide from the FeCl₃. FIG. 2C shows TGA and DTA measurements of the spontaneous, simultaneous reduction of GO to reduced GO (r-GO) and the oxidation of FeCl₃ to iron oxide.

Per FIG. 2A, the thermal de-oxygenation of GO at about 210° C. displays a large exothermic peak of about −1043 joules per gram (J g⁻¹), whereby the graphitic carbon is oxidized to produce CO₂ at about 550° C. The energy released from the de-oxygenation of GO works as an in situ power source to drive the oxidation reaction of FeCl₃. The heat required to drive the oxidation reaction of FeCl₃ to iron oxide, per FIG. 2B, is about 269.6 J g⁻¹, which is only about one fourth the heat released during the reduction of GO. Per FIG. 2C, the GO/FeCl₃ mixture shows an exothermic peak of about −471.6 J g⁻¹ at about 205° C., confirming the spontaneity of the redox reactions the in situ reduction of GO to r-GO, and the oxidation of FeCl₃ to iron oxide. As such, only a small amount of heat, about 50.9 J g⁻¹ as indicated by the endothermic peak at about 100° C., equivalent to a 7 W CO₂ laser, is required to initiate the reaction of the GO/FeCl₃ mixture. All measurements were performed under air.

Physical Characterization of LSG/Fe₃O₄ Nanocomposites

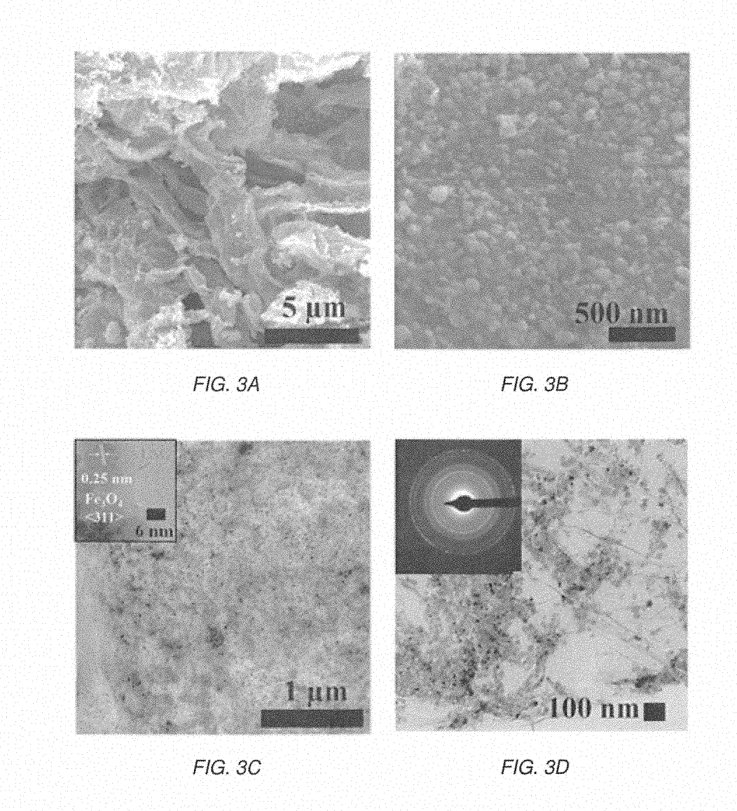

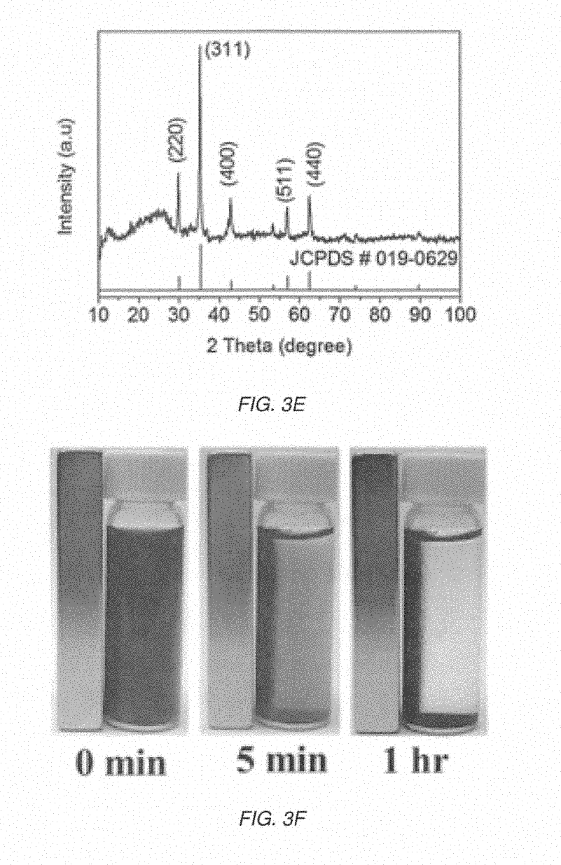

FIG. 3A shows a scanning electron microscope (SEM) image of an exemplary Fe₃O₄ nanoparticles grown on LSG, in accordance with some embodiments. As seen, the three-dimensional (3D) topography of the electrode forms a macro-porous network which provides large internal surface areas for charge storage. This 3D structure is also supported by the iron oxide nanoparticles that act as nano-spacers for the LSG network and provide enough space for the electrolyte ions to interact with the entire electroactive surface of the electrode, allowing for more efficient charge storage.

FIG. 3B shows a high-magnification SEM image of an exemplary LSG/Fe₃O₄, in accordance with some embodiments. As seen, the iron oxide nanoparticles are well dispersed within the conductive LSG framework, whereby the graphene forms a very strong (i.e., close) connection between each iron oxide nanoparticle. This strong bond prevents the aggregation of the iron oxide nanoparticles and the restacking of the graphene layers, to enhance electron transport and stability during cycling processes.

FIG. 3C shows a transverse electromagnetic (TEM) image of an exemplary LSG/Fe₃O₄ nanocomposite, in accordance with some embodiments. As seen, the exemplary laser synthesized LSG/Fe₃O₄ nanocomposite exhibits a uniform dispersion of iron oxide nanoparticles tightly bonded to the LSG. The inset in FIG. 3C further shows the <311> crystallinity of the exemplary LSG/Fe₃O₄ nanocomposite, and a d-spacing of about 0.25 nm. This unique structure provides an efficient pathway to capture the redox capacitance from Fe₃O₄ nanoparticles throughout the conductive LSG network.

FIG. 3D shows a high-resolution TEM image of an exemplary selected electron area diffraction pattern of an exemplary Fe₃O₄ in the LSG composite, in accordance with some embodiments. The inset of FIG. 3D shows that the d-spacings of the peaks that are calculated from the positions of the diffraction rings. These calculated peaks are in good agreement with reference data for Fe₃O₄ shown in Table 1.

TABLE 1

d-spacing (nm)

| Miller Index (hkl) | Reference | Measured* |
|---|---|---|
| 220 | 0.296 | 0.297 |
| 311 | 0.253 | 0.253 |
| 400 | 0.210 | 0.210 |
| 422 | 0.171 | 0.171 |
| 511 | 0.161 | 0.161 |
| 440 | 0.148 | 0.148 |

FIG. 3E shows an X-ray diffraction pattern of an exemplary LSG/Fe₃O₄ nanocomposite, in accordance with some embodiments. As seen, the diffraction peaks of the X-ray diffraction pattern of the exemplary LSG/Fe₃O₄ nanocomposite are perfectly indexed to Fe₃O₄ (per JCPDS 019-0629) to confirm that the iron oxide nanoparticles are indeed Fe₃O₄. The LSG exhibits a weak broad peak at about 25° and unconverted GO peaks appear at about 11° to show the exemplary LSG/Fe₃O₄ nanocomposite is mainly composed of LSG and Fe₃O₄.

FIG. 3F shows a photograph of an exemplary LSG/Fe₃O₄ nanocomposite dispersed in an aqueous solution without and with an external magnetic field, in accordance with some embodiments. The magnetism of the LSG/Fe₃O₄ nanoparticles dispersed in an aqueous solution is shown by upon first application of a magnet, under magnet force for about 5 minutes, and under magnetic force for about 1 hour. As seen, the LSG/Fe₃O₄ nanoparticles in aqueous solution possess excellent magnetic properties and display oriented movement enabling magnetic separation.

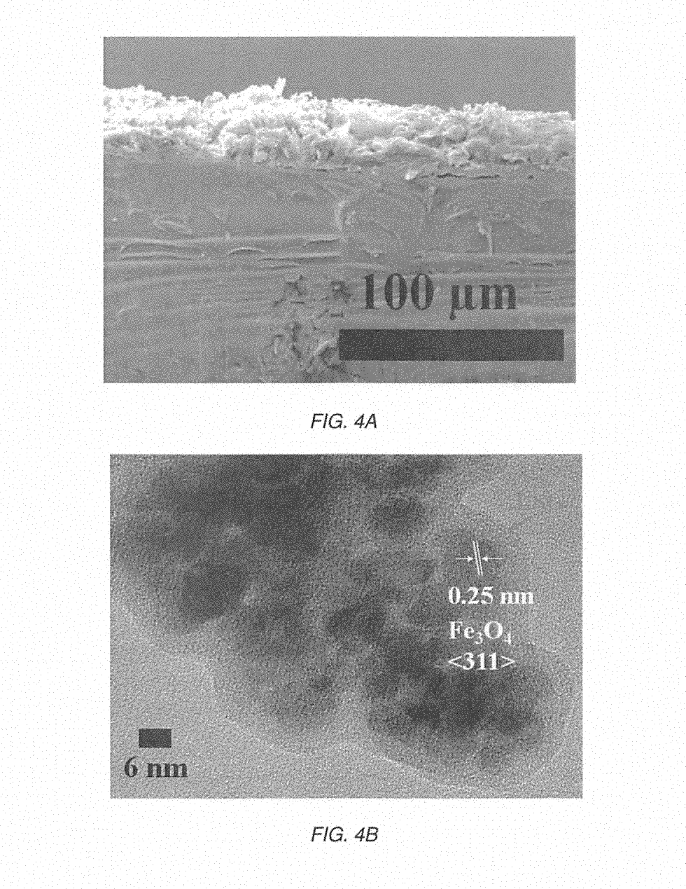

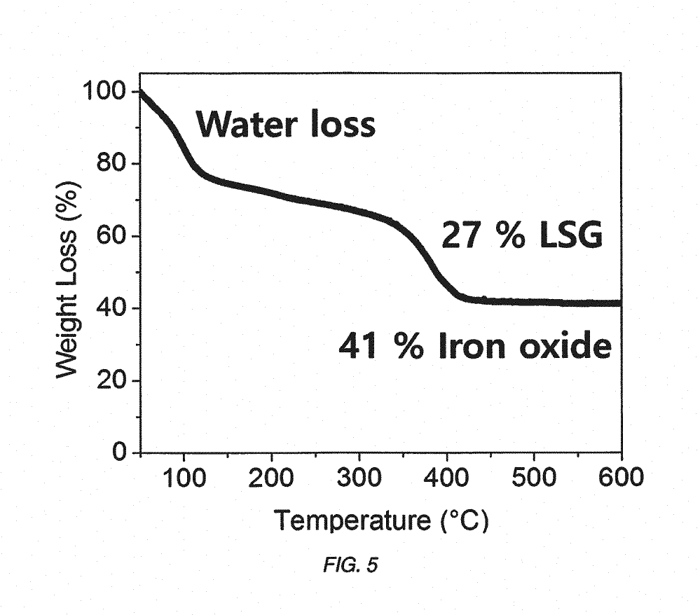

FIG. 4A shows a cross-sectional SEM image of an exemplary LSG/Fe₃O₄ film on a plastic substrate, in accordance with some embodiments. As seen, the thickness of the LSG/Fe₃O₄ film is about 18.4 μm.

FIG. 4B shows an exemplary high-resolution TEM image of the d-spacing of an exemplary Fe₃O₄, in accordance with some embodiments. This image shows that the LSG sheets are each wrapped around a 6-10 nm sized Fe₃O₄ nanoparticle and confirms the <311> planes of Fe₃O₄ crystals per FIG. 3C.

FIG. 5 shows a TGA of an exemplary LSG/Fe₃O₄ nanocomposite, in accordance with some embodiments. As seen, the Fe₃O₄ content of the electrode is about 41 percent by weight.

LSG/Fe₃O₄ Electrodes and a Symmetric LSG/Fe₃O₄ Supercapacitor in a 1.0 M Na₂SO₄ Electrolyte

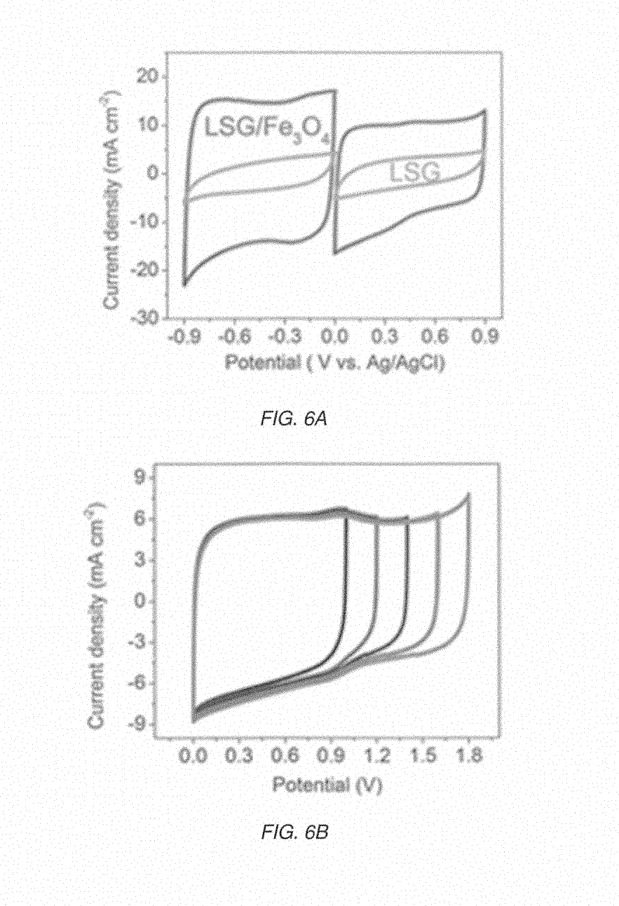

FIG. 6A shows cyclic voltammetry (CV) curves of an exemplary three-electrode setup of LSG and LSG/Fe₃O₄ electrodes at 50 millivolts per second (mV s⁻¹), in accordance with some embodiments. FIG. 6B shows CV curves of an exemplary three-electrode setup of LSG and LSG/Fe₃O₄ electrodes at 70 mV s⁻¹, in accordance with some embodiments.

Negative and positive voltage window tests of three-electrode cells and two-electrode symmetric supercapacitor pouch cells with a 1.0 M Na₂SO₄ electrolyte at scan rated of about 50 mV s⁻¹ and 70 mV s⁻¹ exhibit a rectangular shape. The significant increase in the capacitance therein, compared with that of bare LSG, indicates that iron oxide contributes to the charge storage through reversible redox reactions. Further, the rectangular shape of the CV curves indicates that Fe₃O₄ stores charge mainly through adsorption pseudo-capacitance as opposed to through an intercalation faradaic reaction. This charge storage may be attributed to the ultra-small particle size of the Fe₃O₄ nanoparticles (about 6 nm), which limits redox reactions to the surfaces. During the faradaic processes at the iron oxide nanoparticles, electrons coupled with the highly conductive macro-porous LSG framework enable higher energy densities without reduced power densities. Further, the positive and negative voltage windows of the LSG/Fe₃O₄ electrode with the 1.0 M Na₂SO₄ electrolyte reveal ideal CV shapes without a significant increase in the cathodic or anodic current, which signifies that neither H₂ on the negative electrode nor O₂ on the positive electrode are produced. As such, due to the strong solvation energy of the sodium cations and sulfate anions, the electrolyte decomposition voltage is higher than the thermodynamic value of about 1.23 V. Further, the strong solvation energy of the sodium cations and sulfate anions provides strong bonds in the solvation shell and prevents water decomposition up to about 1.8 V. In this potential range, energy is consumed to break bonds in the solvation shell instead of causing the decomposition of water.

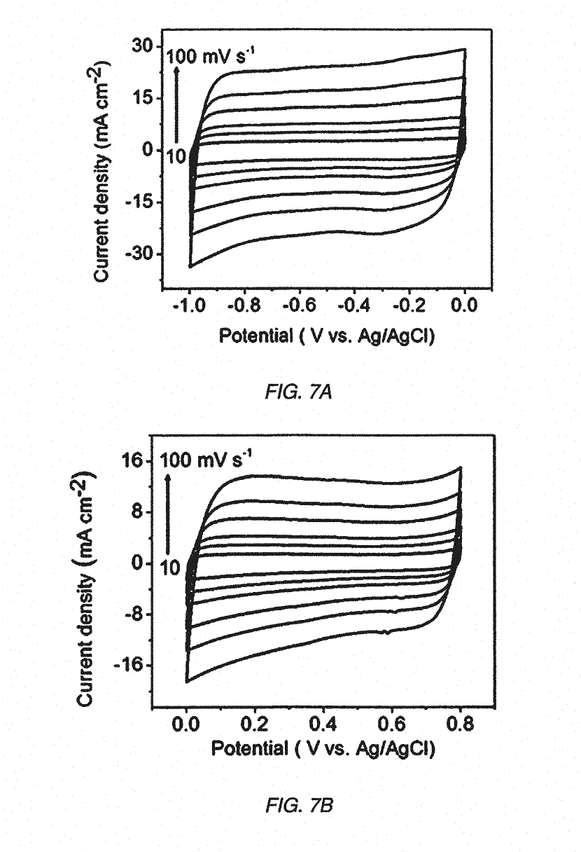

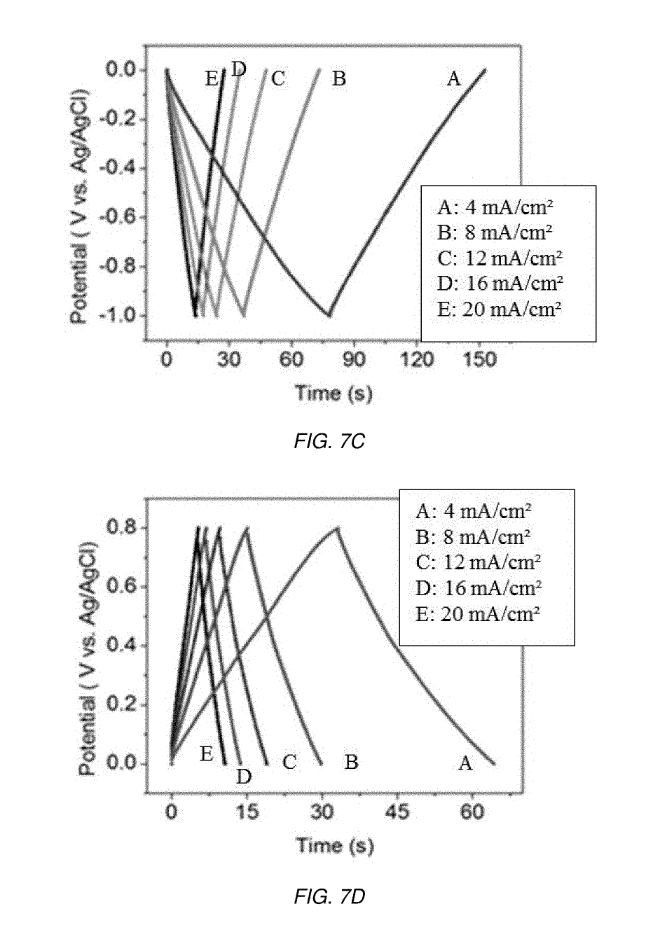

FIG. 7A shows CV curves of the negative voltage window (0 V to −1.0 V vs. Ag/AgCl) of an exemplary three LSG/Fe₃O₄ electrode device in 1.0 M Na₂SO₄ at different scan rates of 10, 20, 30, 50, 70, and 100 mV s⁻¹. FIG. 7B shows the same CV curves of the positive voltage window (0 V to 0.8 V vs. Ag/AgCl) of the device of FIG. 7A at different scan rates of 10, 20, 30, 50, 70, and 100 mV s⁻¹. FIG. 7C shows charge-discharge (CC) curves of the negative voltage window (0 V to −1.0 V vs. Ag/AgCl) of an exemplary LSG/Fe₃O₄ electrode at different current densities. FIG. 7D shows the same CC curves of the positive voltage window (0 V to 0.8 V vs. Ag/AgCl) of an exemplary LSG/Fe₃O₄ electrode at different current densities. As seen, the CVs retain their rectangular shapes with increasing scan rates up to about 100 mV s⁻¹, and an ideal triangular shape is observed in the CC curves at different current densities, which indicates the high rate capability of the electrode in both positive (0 V to about 0.8 V vs. Ag/AgCl) and negative (0 V to about −1.0 V vs. Ag/AgCl) voltage windows. The areal specific capacitances of the exemplary LSG/Fe₃O₄ electrode in the negative and positive voltage windows are about 264 mF cm⁻² (about 691 F g⁻¹) and about 137 mF cm⁻² (about 357 F g⁻¹) at a scan rate of about 20 mV s⁻¹, respectively.

In some embodiments, the two electrodes have the same chemical composition (Fe₃O₄ nanoparticles on 3D porous graphene framework), whereby some components store more charge than others depending on the polarity of the electrode. Specifically, capacitance of the negative electrode may mainly arise from Fe₃O₄ nanoparticles, whereas graphene may dominate charge storage in the positive electrode. In the negative electrode, the conducting LSG network may act as a 3D current collector, to provide electron “superhighways” for charge storage and delivery, while the nanostructured Fe₃O₄ enables fast and reversible faradaic reactions with short ionic diffusion pathways. The 3D porous structure of the electrode allows for the full utilization of the capacitive properties of Fe₃O₄ and exhibits ultrahigh capacitance of the negative electrode.

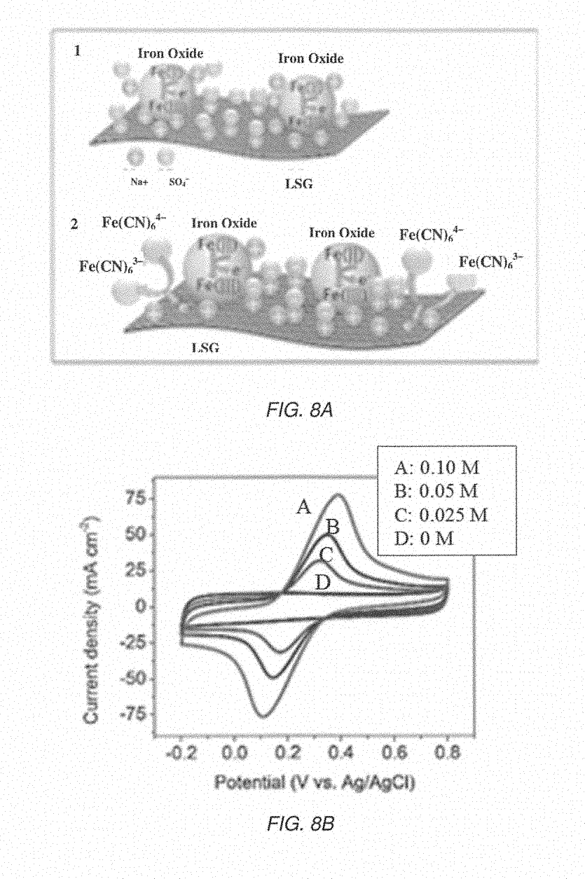

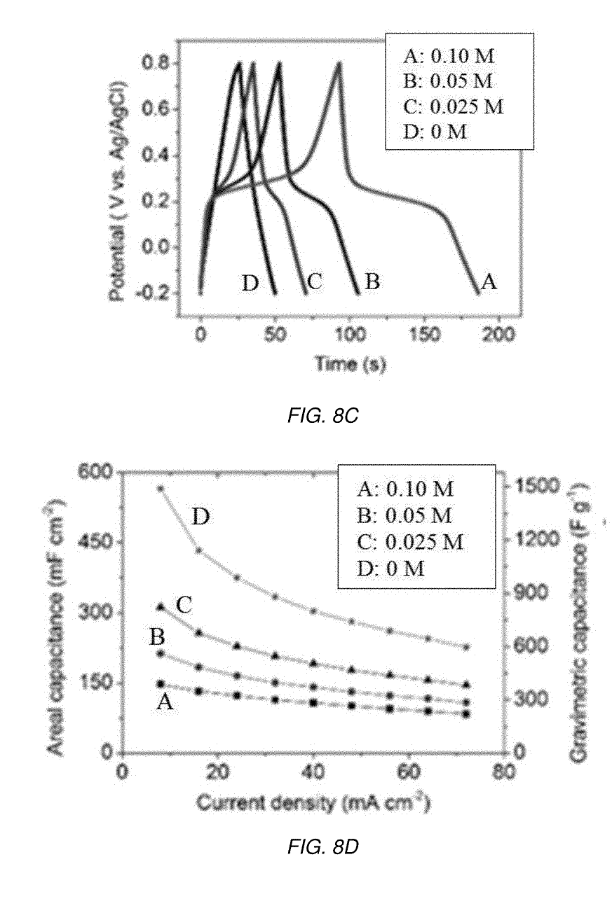

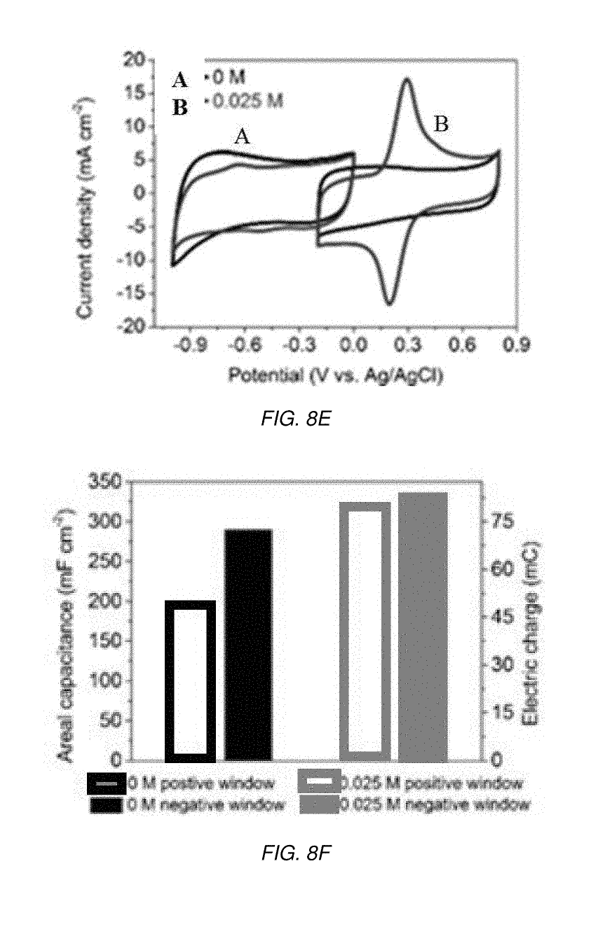

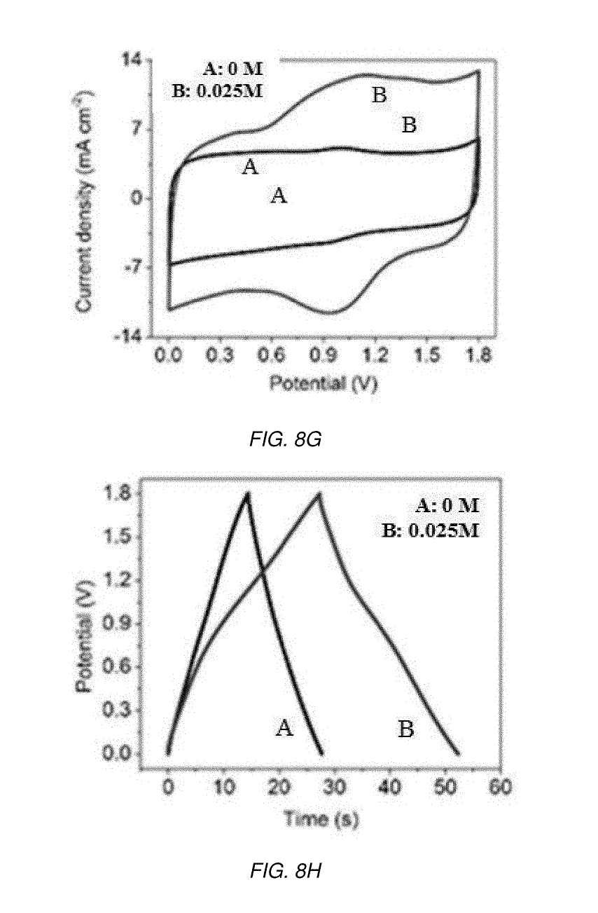

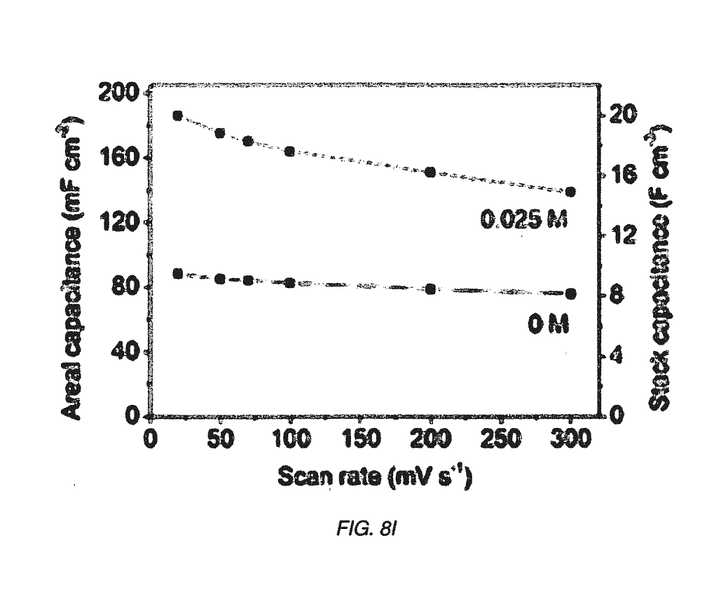

As, per FIGS. 8A-8I, the electrical charge of the positive and negative electrodes may be balanced to store equal charge through the use of a redox active electrolyte.

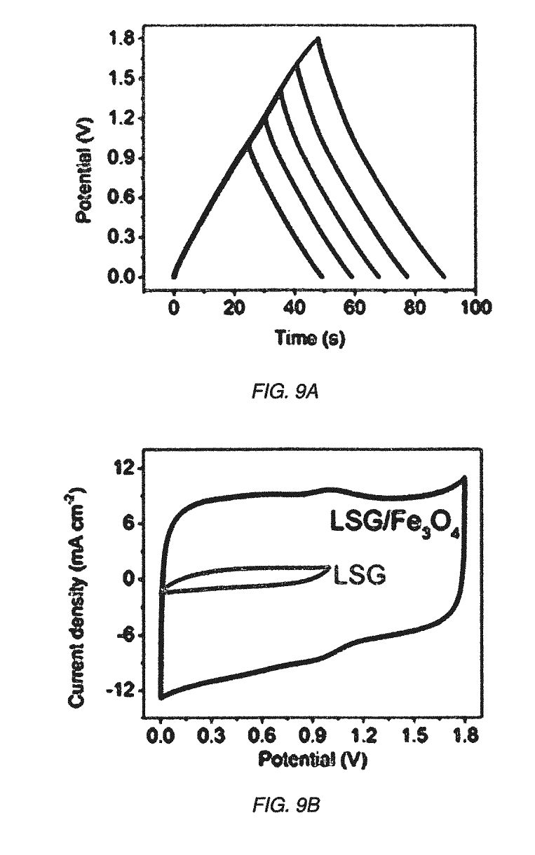

The working voltage of a symmetric three-electrode LSG/Fe₃O₄ supercapacitor in an aqueous electrolyte comprising about 1.0 M Na₂SO₄ is expected to be about 1.8 V based on the operating voltage window results. FIG. 6B and FIG. 9A show CV and CC charts, respectively, of an exemplary symmetric LSG/Fe₃O₄ supercapacitor with two identical LSG/Fe₃O₄ electrodes separated by an ion porous separator, at voltage intervals of about 0.2 V from about 0.8 V and to about 1.8 V at a scan rate of about 70 mV s⁻¹ for CV curves and a current density of about 4 mA cm⁻² for CC curves. As seen, the rectangular CV shape at 1.8 V, without any significant increase of anodic current displays the ideal capacitive behavior of the cell, without any decomposition of the aqueous electrolyte with hydrogen or oxygen evolution.

In addition, per FIG. 9A, the ideal triangular shape CC curves exhibit very small IR drops and a high capacitance at voltages of up to about 1.8 V, and that as such, the electrolyte is stable and does not decompose. FIG. 9B shows a comparison between the performance of an exemplary bare LSG symmetric supercapacitor and an exemplary LSG/Fe₃O₄ symmetric supercapacitor, at a scan rate of about 100 mV s⁻¹, whereby, even at a high operating voltage of about 1.8 V, the specific capacitance of an LSG/Fe₃O₄ supercapacitor is about 10 times larger than that of the bare LSG. As such, the operational voltage window of 1.8 V can be obtained for the exemplary symmetric LSG/Fe₃O₄ supercapacitor.

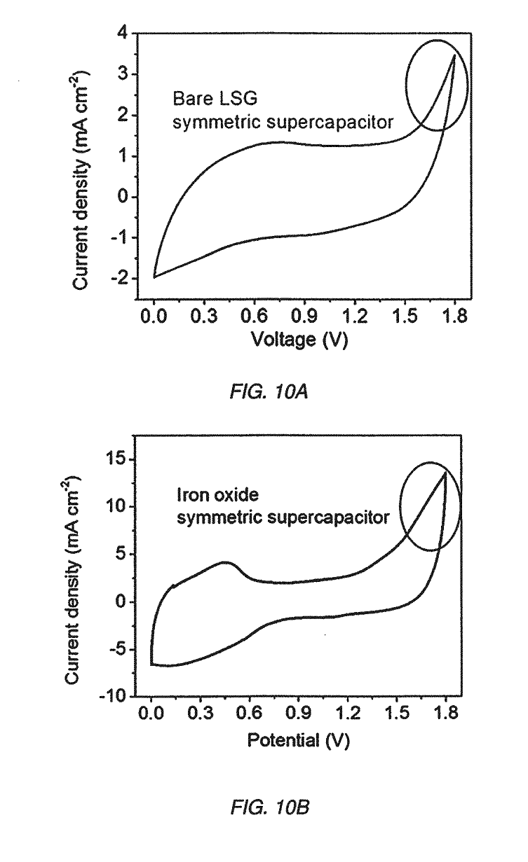

By contrast, CV curves of an exemplary bare LSG symmetric supercapacitor and an exemplary pristine iron oxide symmetric supercapacitor are shown in FIGS. 10A and 10B at about 1.8 V with a current density of about 100 mV s⁻¹, whereby both exemplary supercapacitors obviously suffer from decomposition of the aqueous electrolyte above about 1.2 V. The comparison between the performance of the symmetric three-electrode LSG/Fe₃O₄ supercapacitor in an aqueous electrolyte comprising about 1.0 M Na₂SO₄ indicates the remarkable improvement of the extended operational voltage and capacitance that arises from the combination of the special architectural form of the LSG/Fe₃O₄ electrode with an about 1.0 M Na₂SO₄ electrolyte.

Although the LSG/Fe₃O₄ supercapacitor herein may be classified as a symmetric supercapacitor, per the electrode composition and loading mass, its composition may function like an asymmetric device, whereby the majority of the charge stored in the positive and negative electrodes stems from the graphene and Fe₃O₄, respectively. As such, the asymmetric charge storage mechanism increases the voltage window of the aqueous supercapacitor to about 1.8 V.

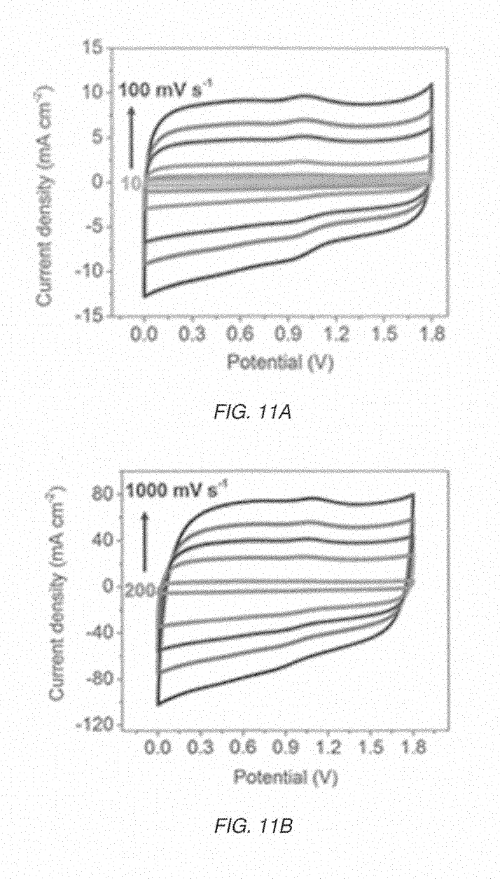

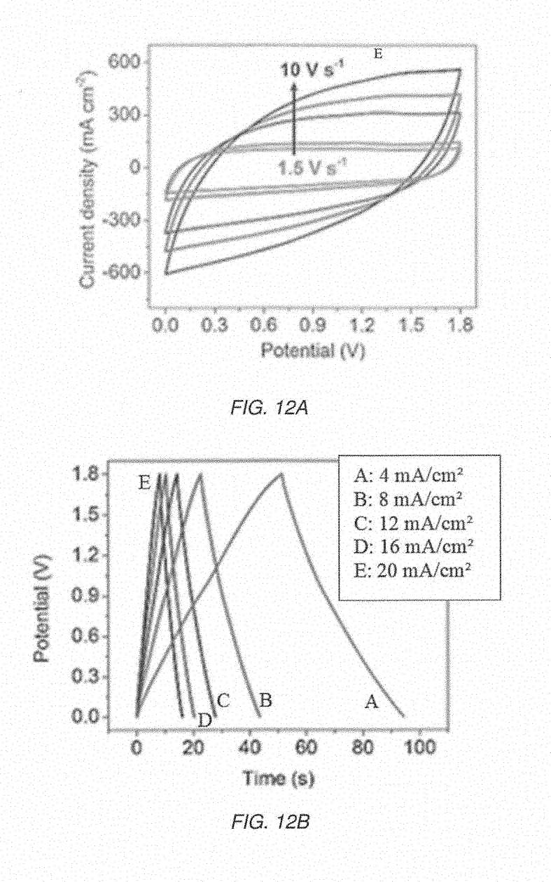

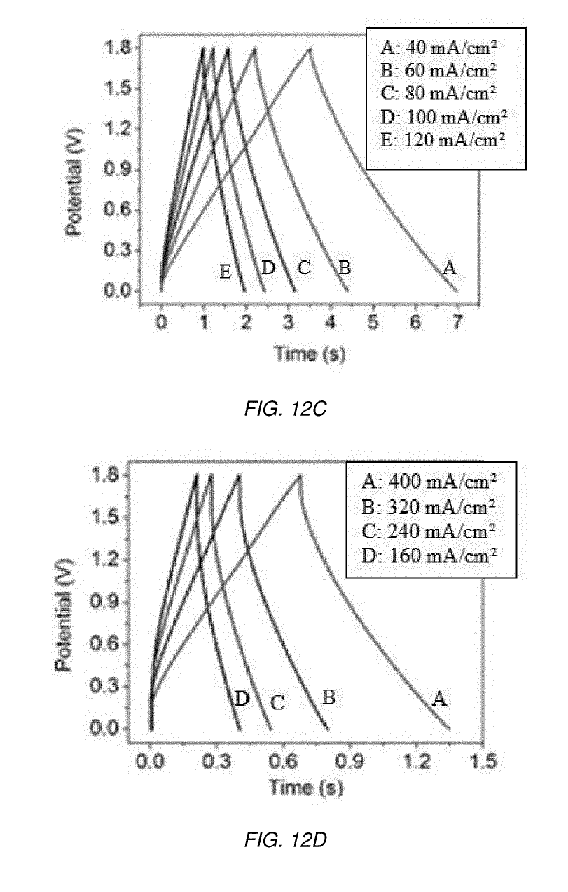

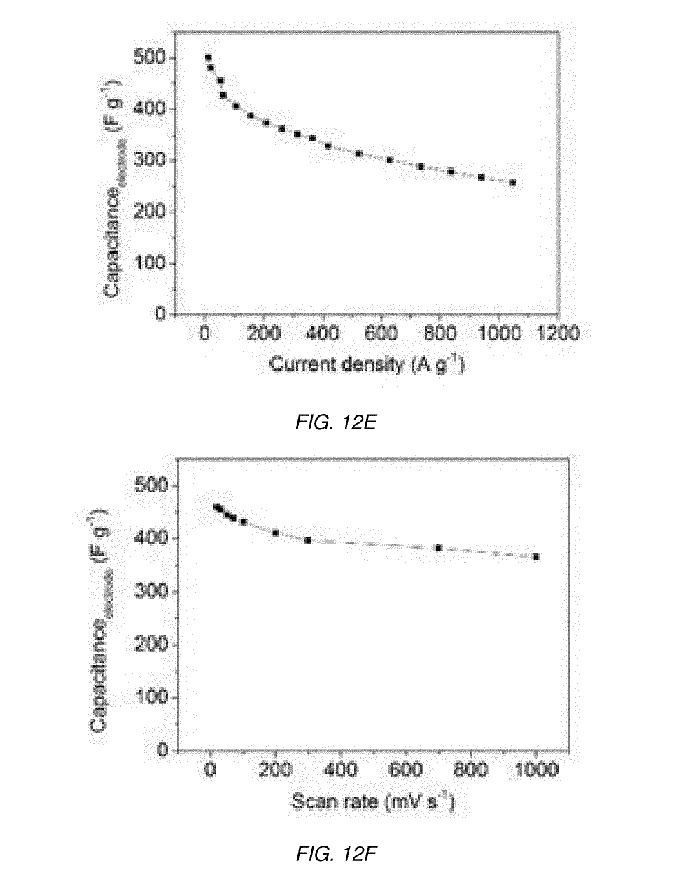

FIG. 11A and FIG. 11B show the CV shape of the exemplary LSG/Fe₃O₄ supercapacitor with a potential window of about 1.8 V under different scan rates from about 10 mV s⁻¹ to about 1000 mV s⁻¹. The rectangular shape of the CV curves therein is retained at very high scan rates of about 1000 mVs⁻¹. FIG. 12A further confirms the rectangularity of the CV curves of the exemplary LSG/Fe₃O₄ supercapacitor even at about 10,000 mV s⁻¹. As such, the exemplary LSG/Fe₃O₄ symmetric supercapacitor exhibits ideal capacitance with a high rate capability of about 1.8 V.

FIGS. 12B-12D show CC curves of the exemplary LSG/Fe₃O₄ supercapacitor under different current densities from about 4 mA cm⁻² to about 400 mA cm⁻², whereby the ideal triangular curve shape displays the high performance of the exemplary LSG/Fe₃O₄ supercapacitors. The specific capacitance of an exemplary two-electrode LSG/Fe₃O₄ supercapacitor was measured at about 460 F g⁻¹ (about 176 mF cm⁻²) per electrode through the discharge curve.

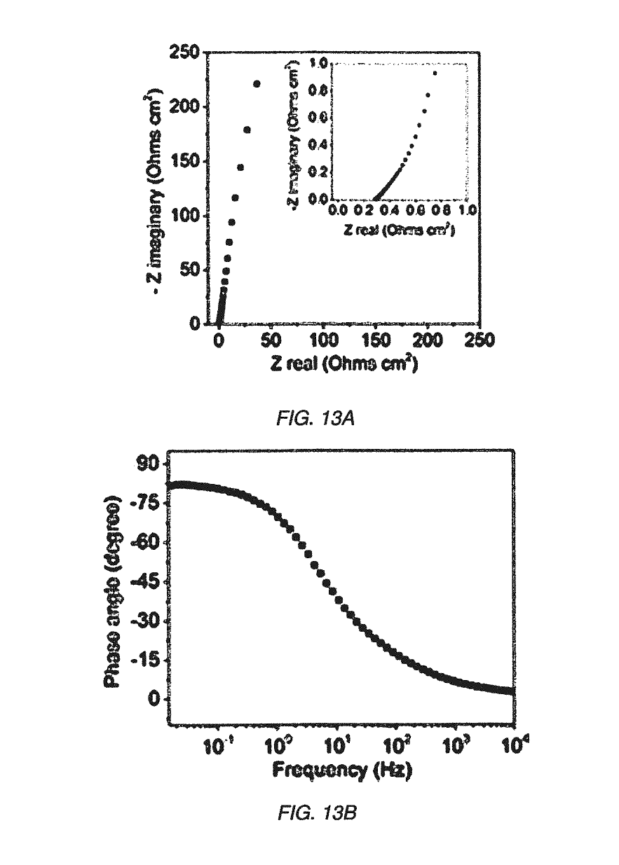

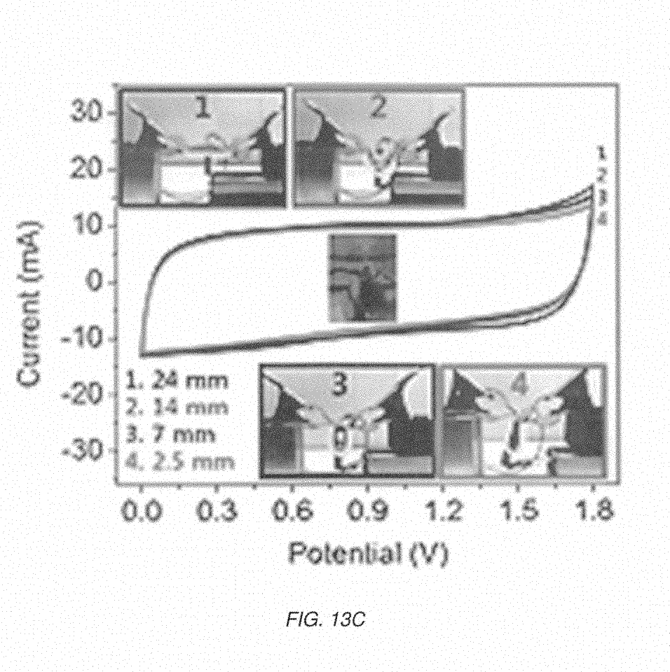

As seen in FIG. 12E, the exemplary LSG/Fe₃O₄ supercapacitor can deliver about 300 F g⁻¹ at an ultrahigh current density of about 1100 A g⁻¹. The specific capacitance per electrode, the areal capacitance for the device, and the entire stack capacitance for the supercapacitor (including current collector and separator) under different current densities may be calculated per the data from FIG. 12E and FIG. 12F. Thus, the exemplary LSG/Fe₃O₄ supercapacitor exhibits excellent rate capability through the special 3D architectural form of the LSG/Fe₃O₄ which enables fast ionic and electronic diffusion within the electrode. In addition, the highly conductive and porous structure of LSG provides an efficient charge transfer mechanism for iron oxide nanoparticles during redox reactions, as confirmed by the x-intercept of 0.35 Ωcm², representing a very low equivalent series resistance, per the Nyquist plot in FIG. 13A. Further, the lack of semicircles, and the vertical straight up line at low frequency, per FIG. 13A, indicates no charge transfer resistance, fast ionic diffusion to the electrode, and fast electron transfer during the redox reactions.

Further, the Bode plot of the exemplary LSG/Fe₃O₄ supercapacitor in FIG. 13B, displays a maximum phase angle of about −82° which is close to the about −90° for ideal capacitors, and a frequency response time (inverse of the characteristic frequency f₀=7 Hz at a phase angle of about −45°) of about 0.14 s shows a much faster response time than many conventional activated carbon electrochemical capacitors. This rapid frequency response may be attributed to the excellent 3D architecture and the interconnected structure of the exemplary LSG/Fe₃O₄ electrodes, which enables strong interaction between LSG and the Fe₃O₄ nanoparticles, an increased accessibility of ions to the macroporous LSG, and fast charge transfer to the iron oxide during the faradaic reactions.

Provided herein is a highly flexible, solid-state supercapacitor comprising two LSG/Fe₃O₄ electrodes and a polyvinyl alcohol (PVA)-Na₂SO₄ gel electrolyte. FIG. 13C displays CV curves at about 100 mV s⁻¹ of the exemplary LSG/Fe₃O₄-PVA-Na₂SO₄ supercapacitor while flat, and under bending radii of about 14 mm, about 7 mm, and about 2.5 mm. As seen, only negligible differences exist between the CV curves of the flat and highly bent (2.5 mm bend radii) of the exemplary LSG/Fe₃O₄-PVA-Na₂SO₄ supercapacitor. As such, since the large porous space within the 3D interconnected LSG framework, accommodates the deformation of the electrode, the mechanical bending has little to no influence on the ionic and electronic diffusion between the gel electrolyte and the LSG/Fe₃O₄ electrode.

FIG. 13C insets show an exemplary bent flexible supercapacitor turning on a light-emitting diode, indicating excellent capacitive performance even under harsh mechanical stress.

### Electrode Electrochemical Properties

Although pseudo-capacitor research is commonly focused on improving reversible redox reactions through electrode materials such as metal oxides or conducting polymers, such a reliance on solid electrode materials may limit pseudo-capacitance improvements. As such, capacitance may be improved through utilization of a redox-active electrolyte (RE) with LSG/Fe₃O₄ and ferricyanide/ferrocyanide RE electrodes.

Provided herein is an asymmetric capacitor mechanism, wherein the positive and negative electrodes are formed of the same chemical composition and loading mass, and wherein the charge is balanced with a redox electrolyte to effectively utilize pseudo-capacitance from a solid electrode and the faradaic reaction from a liquid electrolyte. As such, capacitance in the negative electrode originates from the active materials on the electrode (LSG/Fe₃O₄), whereby the solid positive electrode contributes to charge storage and whereby the electrolyte provides capacitance through redox.

From the solid LSG/Fe₃O₄ electrode, iron oxide particles exhibit pseudo-capacitive properties through reversible charge-transfer processes, according to the following equation:

Fe^{Z+} [symbol] Fe^{(Z+N)+}+Ne⁻;0≤Z≤2,1≤N≤3 EQ. 1

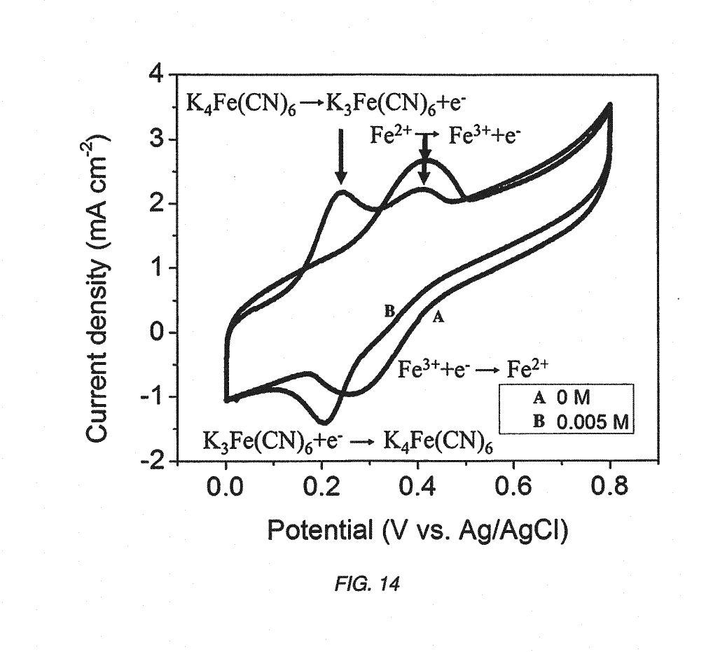

The oxidation and reduction peaks appear at 0.4 V and 0.28 V, respectively (see FIG. 14 curve A). The charging process entails an oxidation process from Fe²⁺ to Fe³⁺, while the discharging process comprises a reduction process from Fe³⁺ to Fe²⁺.

From the RE side, the oxidation and reduction are attributed to the faradaic reaction shown in the following equation:

Fe(CN)₆⁴⁻ [symbol] Fe(CN)₆³⁻+e⁻ EQ. 2

The capacitance of each electrode (measured in a three-electrode device) was calculated from CC curves at different current densities using the following formula:

$$Specifc {C}_{electrode} ( F {g}^{- 1} ) = \frac{2 * Current ( A ) * \int U ( Volt ) dt ( sec )}{{U}^{2} * Mass ( g )} \qquad EQ . 3$$

Mass refers to the mass of LSG/Fe₃O₄ active materials, while time and U voltage were obtained from the discharge curve.

The specific capacitance, energy density, and power density of the full device were also were calculated based on both CV profiles and galvanostatic CC curves.

For the CV technique, the capacitance was calculated by integrating the discharge current vs. potential plots using the following equation:

$$Specific {C}_{device} ( F {g}^{- 1} ) = \frac{\int idV ( A ) ( V )}{v ( \frac{V}{s} ) U ( V ) * Mass ( g )} , \qquad EQ . 4$$

where i is current (A), V is potential, v is the scan rate (V/s), and U is the operating potential window. Mass refers the mass of active materials (two electrodes of LSG/Fe₃O₄ and 0.025 M redox additive).

$$Specific {C}_{device} ( F {cm}^{- 3} ) = \frac{\int idV ( A ) ( V )}{v ( \frac{V}{s} ) U ( V ) * Volume ( {cm}^{3} )} \qquad EQ . 5$$

Volume is calculated based on the whole device (current collector, active materials, electrolyte, and separator) with no packaging.

The specific capacitance of the electrode was calculated from the full cell.

Specific C_{electrode} (Fg⁻¹)=4*C_{device} (Fg⁻¹) EQ. 6

The specific energy density of the device was calculated through discharge curve from CC:

$$\begin{matrix} Specific {E}_{device} ( Wh {kg}^{- 1} ) = \frac{I ( A ) \int U ( t ) dt ( Volt ) ( hr )}{Mass ( kg )} & EQ . 7 \\ Specific Capacity ( mAh {g}^{- 1} ) = \frac{E device ( Wh {kg}^{- 1} )}{Voltage ( V )} * \frac{1000 ( mA )}{( A )} * \frac{( kg )}{1000 ( g )} & EQ . 8 \\ Specific {E}_{device} ( Wh {cm}^{- 3} ) = \frac{I ( A ) \int U ( t ) dt ( Volt ) ( hr )}{volume ( {cm}^{3} )} & EQ . 9\end{matrix}$$

The specific power density of device was calculated as follows:

$$\begin{matrix}Specific {P}_{device} ( W {kg}^{- 1} ) = \frac{Energy density ( Wh / kg )}{Time ( hr )} & EQ . 10 \\ Specific {P}_{device} ( W {cm}^{- 3} ) = \frac{Energy density ( Wh / {cm}^{3} )}{Time ( hr )} & EQ . 11\end{matrix}$$

Electrochemical Performance of LSG/Fe₃O₄ Electrodes and a Symmetric Supercapacitor in an [Fe(CN)₆³⁻/Fe(CN)₆⁴⁻] Redox-Active Electrolyte

FIG. 14 shows the CV curves at potential range from 0 to about 0.8 V at about 5 mV s⁻¹ of an exemplary three-LSG/Fe₃O₄ electrode device at 5 mV s⁻¹ containing a high percentage of Fe₃O₄ (about 82%) with, and without a 0.005 M RE [Fe(CN)₆³⁻/Fe(CN)₆⁴⁻] and 1.0 M Na₂SO₄ electrolyte. As seen, the redox pair of the [Fe(CN)₆³⁻/Fe(CN)₆⁴⁻] electrolyte contributes to the capacitance and stabilizes the cycle life at about 1.8 V.

In FIG. 14, the 0 M CV shows two independent oxidation peaks at about 0.22 V and about 0.4 V. The 0.4 V broad oxidation peak is superimposed with a 0.005 M oxidation peak, indicating that this oxidation peak is from the exemplary LSG/Fe₃O₄ electrode and the 0.22 V peak is from the RE.

As seen, the redox reaction of the exemplary LSG/Fe₃O₄ electrode and the RE occur independently and simultaneously, with the mechanism depicted in FIG. 8A, whereas both electrode and electrolyte materials are oxidized during charging, and both the electrode and the electrolyte were reduced simultaneously during discharge.

FIGS. 8B and 8C show CV curves of an exemplary LSG/Fe₃O₄ a three-electrode supercapacitor with various concentrations of [Fe(CN)₆³⁻/Fe(CN)₆⁴⁻] in the 1.0 M Na₂SO₄ electrolyte, at a scan rate of 50 mV s⁻¹ and at a current density of 8 mA cm⁻². A very sharp reversible redox peak is seen in FIG. 8B, indicating that the [Fe(CN)₆³⁻/Fe(CN)₆⁴⁻] ions are highly electrochemically active. Moreover, FIG. 8B shows the CV curves with various concentrations of RE ions of 0 M, about in 1.0 M Na₂SO₄. As the RE ion concentration increases, from about 0.025 M to about 0.100 M, the characteristic redox peak increases and the capacitance contributed by the RE ions increases, whereby more RE ions contribute to the faradaic-capacitance and shuttle electrons to the electrode, promoting the high activity of the LSG/Fe₃O₄ electrode.

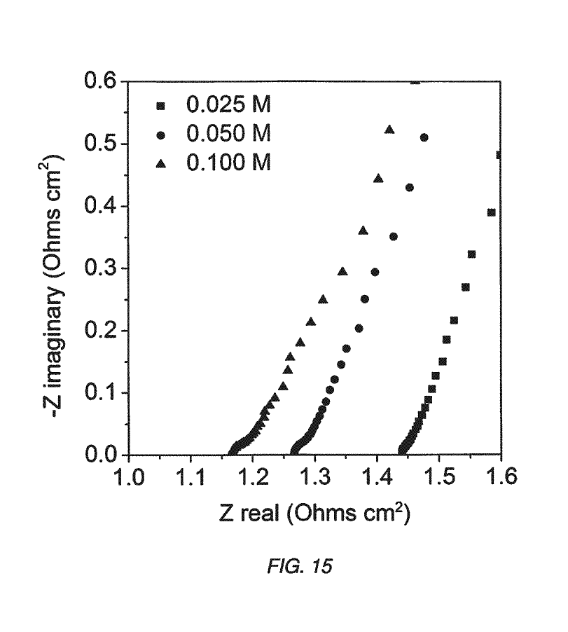

FIG. 8C shows the CC curves of the exemplary LSG/Fe₃O₄ electrode with varying concentrations of redox ions in the electrolyte at a current density of about 8 mA cm⁻². FIG. 8D shows the specific capacitances of the exemplary electrode at various current densities, based the discharge times in the CC curves of FIG. 8D. The exemplary LSG/Fe₃O₄ electrode and the 0.1 M RE device exhibits an ultrahigh specific capacitance of about 1489 F g⁻¹ (about 570 mF cm⁻²) at about 8 mA cm⁻², which is about four times larger than the capacitance of the pristine 1.0 M Na₂SO₄ electrolyte. This remarkable amount of capacitance may arise from the faradaic processes at the solid iron oxide nanoparticles coupled with the RE and promoting the electron transfer between the exemplary LSG/Fe₃O₄ electrodes. The Nyquist plot, as shown in FIG. 15, further confirms the high conductivity of the exemplary LSG/Fe₃O₄ electrode and [Fe(CN)₆³⁻/Fe(CN)₆⁴⁻] redox-active electrolyte, whereby, as the redox-ion concentration is increased, the intercept of the Nyquist plot values decreases, and a low charge transfer resistance at the electrode-electrolyte interface is observed.

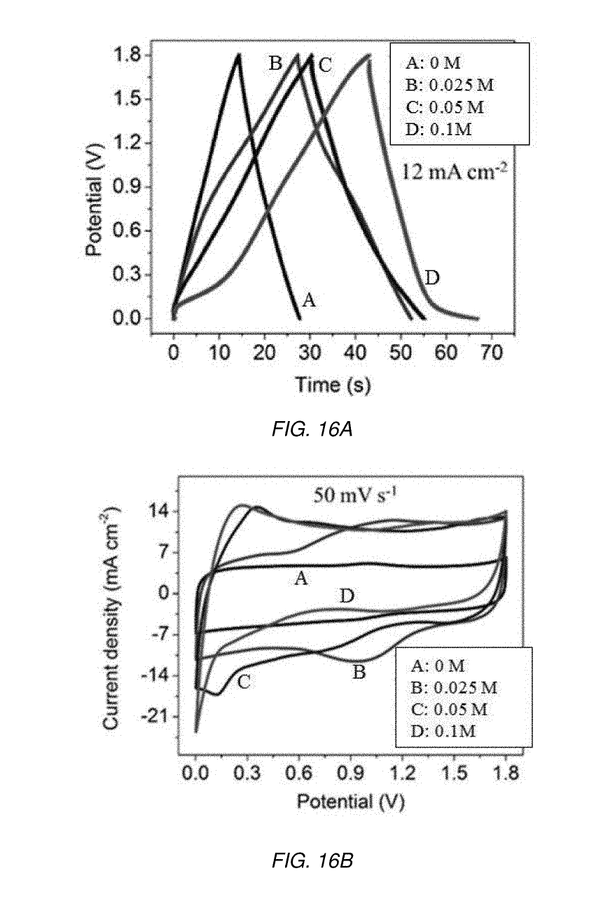

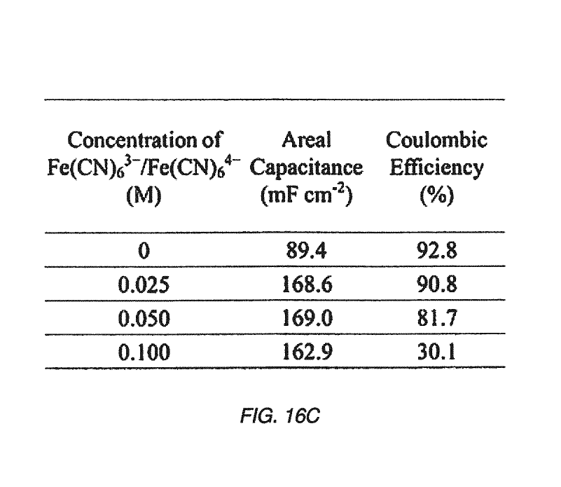

Although two and three-electrode devices are expected to be stable in the same RE with the separator, the two-electrode device exhibits very different performance with a higher concentration of RE, as, for a full supercapacitor, the balance of the electric charge between positive and negative electrodes is critical to obtain a satisfactory capacitive performance and should follow the relationship Q₊=Q₋. FIG. 8E shows CV curves at about 20 mV s⁻¹ without RE and with 0.025 M RE in both positive and negative windows (about 0 to about −1 V and about −0.2 to about 0.8 V) of an exemplary symmetric three-electrode supercapacitor comprising LSG/Fe₃O₄ electrodes. As seen, per the electric charge values for both negative and positive voltage windows in different concentrations of RE, the optimal RE concentration, per FIG. 8F, is about 0.025 M for the symmetric LSG/Fe₃O₄ supercapacitor. Thus increasing RE ion concentration may have a negligible effect on the negative electrode, while only increasing the capacitance of the positive electrode of the exemplary device. Therefore, the increase in the concentration of RE in the electrolyte may not be correlated to an increase in capacitance in the two-electrode device because under a high concentration, the positive and negative charges are not balanced, and a portion of the positive charges is used for the decomposition of the electrolyte instead of charge storage between the negative and positive electrodes, per FIG. 16A. Thus, the exemplary two-electrode device may exhibit a low coulombic efficiency at high concentrations of RE. However, an electrolyte concentration of about 0.025 M in the two-electrode device increases the capacitance without any decomposition of the electrolyte. FIG. 16B shows CV curves at 50 mV s⁻¹, and FIG. 16C shows the areal capacitance and coulombic efficiency at different concentrations of RE, for the exemplary two-electrode device, as listed.

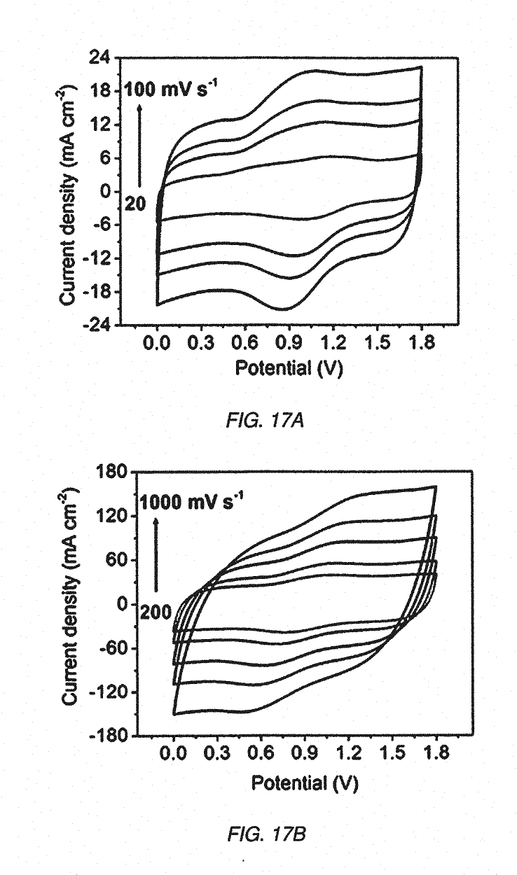

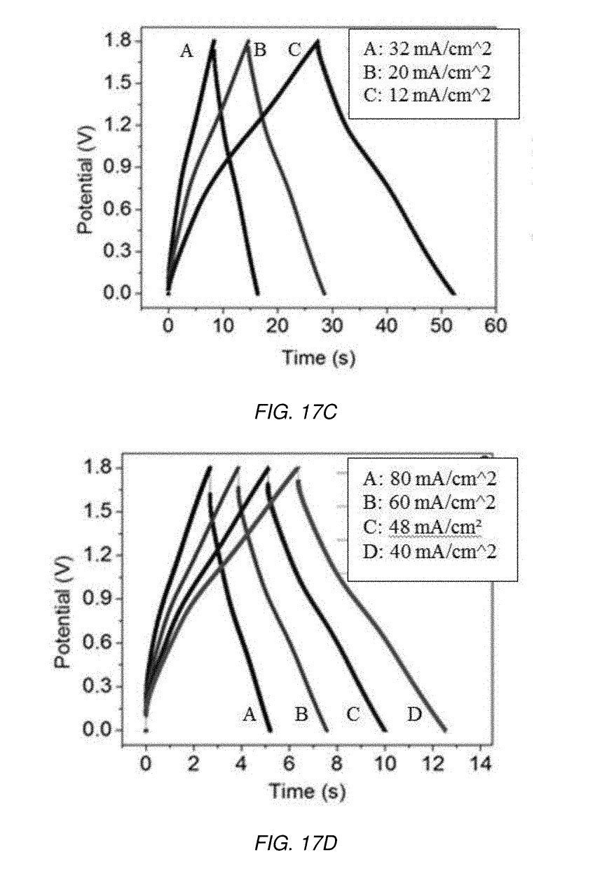

FIG. 8G and FIG. 8H show ideal behavior of the exemplary device, per the CV and CC curves of exemplary two-electrode cells before and after the addition of about 0.025 M RE. In FIG. 8G, the CV curve with the RE shows that the area under the curve increases by a factor of two compared with the normal electrolyte and also shows characteristic redox peaks (at about 1.1 V and about 0.9 V) of the RE. The shape of the CC curves, per FIG. 8H, also follows the about 1.1 V and about 0.9 V redox peaks that appear in the CV curves, associated with a doubling of the discharge time compared with the normal electrolyte. As shown in FIGS. 17A-17D, the exemplary device exhibits a very distinct redox peak, even under a high scan rate (e.g., about 1000 mV s⁻¹) and high current density (e.g., about 80 mA cm⁻²). These results imply that the RE electrolyte experiences incredibly fast electron transfer due to the unique properties of the LSG/Fe₃O₄ electrodes. FIG. 8I shows the areal capacitance and stack capacitance plotted as a function of the applied current density. The stack capacitance was calculated based on the volume of the current collector, the active materials, electrolyte, and separator. Per FIG. 8I, the maximum stack capacitance of the 0.025 M RE reached about 25.6 F cm⁻³ (about 716 F g⁻¹ electrode) at a scan rate of 20 mV s⁻¹ and still retained 19.2 F cm⁻³ (535 F g⁻¹ electrode) at a high scan rate of 300 mV s⁻¹. Further, the stack capacitance of the exemplary device with the 0.025 M RE is about double that of a bare 1.0 M Na₂SO₄ electrolyte. This excellent capacitive behavior may be attributed to the hybrid LSG/Fe₃O₄ electrodes in which both the solid electrode and the RE work synergistically to store charge more effectively.

### Discharge and Leakage Measurements

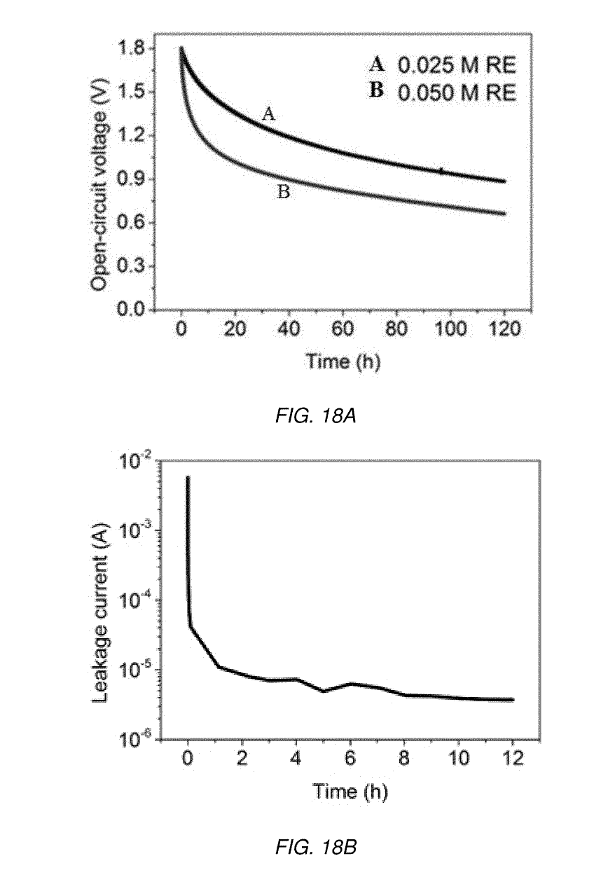

One of the main design considerations for supercapacitors is the rate of self-discharge or how fast the cell loses charge under open circuit conditions. The self-discharge curves obtained after charging up the exemplary device with two different concentrations of redox electrolyte to about 1.8 V for 2 hours is shown in FIGS. 18A and 18B and indicate that the higher the concentration of the redox electrolyte, the faster the self-discharge rate. Specifically, the exemplary devices with 0.025 M RE self-discharges to ½ Vmax (about 0.9 V) in about 120 hours, whereas 0.05 M of RE self-discharges to about 0.9 V in about 40 hours, which is superior to a commercial capacitor that self-discharges to half of a maximum charged voltage in 2 hours (i.e., t_{1/2}Vₘₐₓ=2 hours). In other words, the value of leakage current for exemplary devices of this disclosure is about 0.00368 mA, which is required to maintain the about 1.8 V after holding voltage for about 12 hours. This superior self-discharge performance shows the promise of the LSG/Fe₃O₄ supercapacitors described herein.

Direct Fabrication of LS G/Fe₃O₄ Interdigitated Micro-Supercapacitors

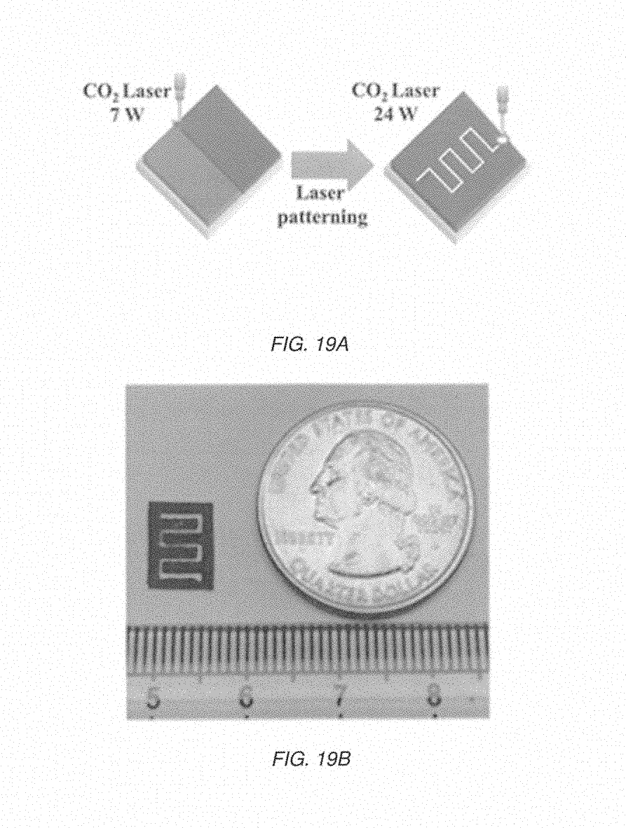

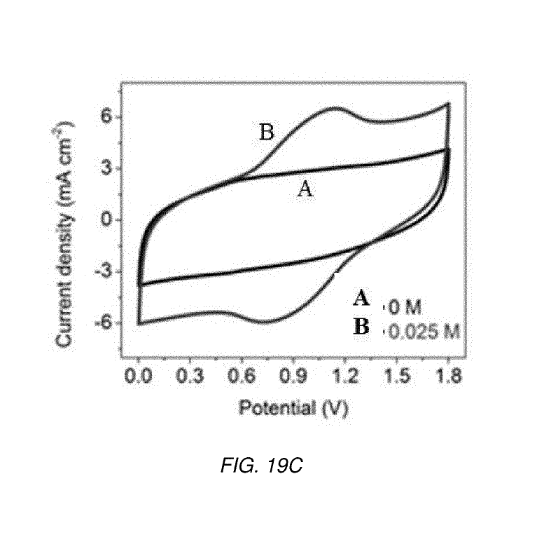

Recent trends in miniaturized portable electronic devices have raised the demand for miniaturized energy storage devices that can be easily integrated into an electronic circuit. Unlike previous techniques that require multiple complex steps, the laser technique described here, per FIG. 19A, may be used for the direct patterning of a micro-supercapacitor to any shape and size within minutes.

An exemplary LSG/Fe₃O₄ electrode film is fabricated under a 7 W CO₂ laser, whereby, once the starting material (FeCl₃+GO) has changed to the LSG/Fe₃O₄ electrode, a 24 W CO₂ laser is used to form the interdigitated finger patterned electrodes. Under the high-power laser, all the active materials and current collector are etched away and work as separators. FIG. 19B shows a micro-supercapacitor with three positive micro-electrodes and three negative micro-electrodes. As seen, the pattern is well defined without any overlap or short circuits between the positive and negative micro-electrodes. This laser technique allows for the fabrication of micro-supercapacitors in one simple step to enable the fabrication of several cells connected together in series and in parallel for energy modules. The micro-supercapacitor modules produced by the methods herein may be prepared in a facile way and are suitable for on-chip integration into electronic circuits without any further processing.

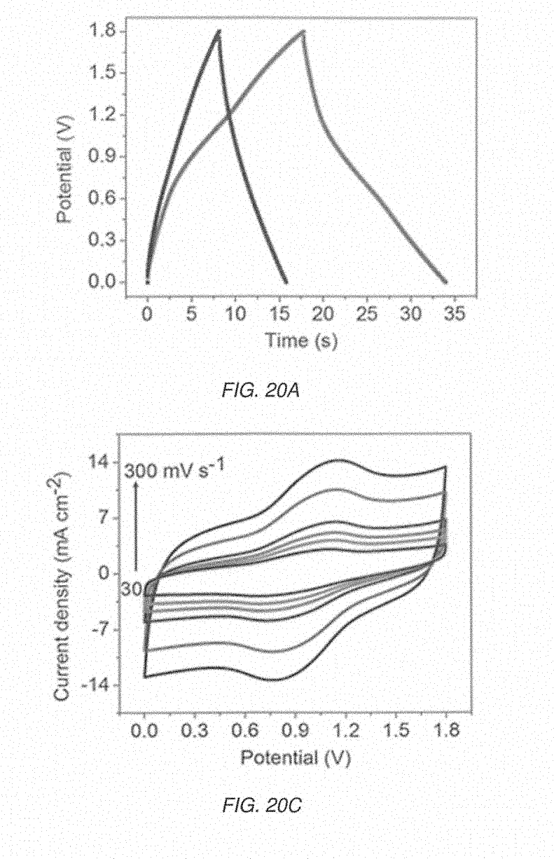

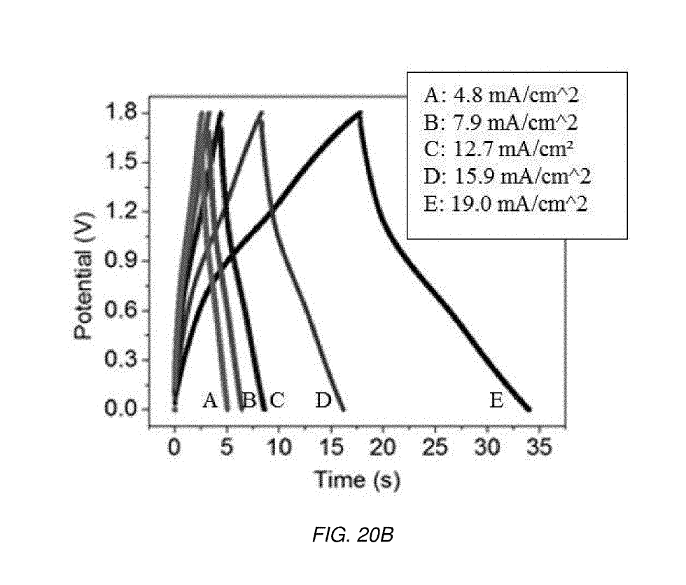

The exemplary micro-supercapacitor with a 1.0 M Na₂SO₄ electrolyte display an ideal CV rectangular shape, per FIG. 19C, even when operated at about 1.8 V under about 100 mV s⁻¹. The distinct redox peaks are observed upon adding about 0.025 M of RE and therein are also noticeable in the CC curves of the exemplary device, per FIG. 20A. Further, the exemplary device, per the CC curves in FIGS. 20A and 20B and the CV curves in FIG. 20C, exhibits a 2.1 times increased capacitance with the use of the RE 0.025 M RE, fast and reversible charge and discharge properties, and variable current densities.

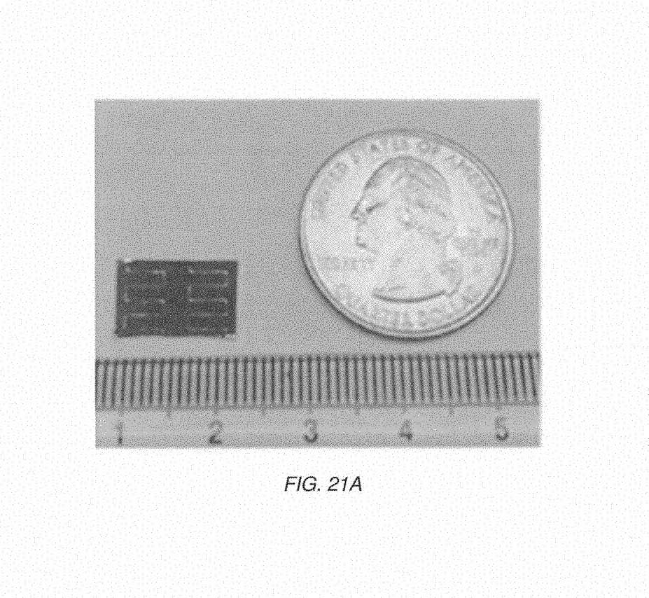

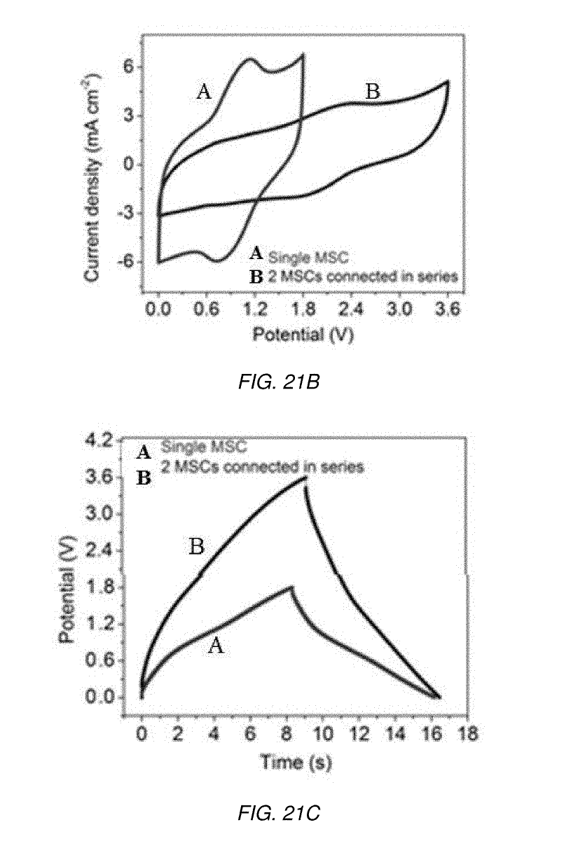

FIG. 21A shows a photograph of an exemplary tandem model with two cells connected in series the electrochemical performance of which is shown in FIG. 21B and FIG. 21C. The voltage of the module is about 3.6 V, compared with about 1.8 V for a single cell. As seen in FIG. 21C, the CC curve for the exemplary tandem device displays a very low voltage drop as well, indicating an excellent performance with low internal resistance when connecting these micro-supercapacitors in series. This confirms the feasibility of the micro-supercapacitor modules for real applications.

Performance Comparison of LSG/Fe₃O₄ Based Supercapacitors with LSG/Fe₃O₄ Based Micro-Supercapacitors

Table 2 below shows a summary of the specific capacitance, energy density, and power density of an exemplary symmetric LSG/Fe₃O₄ supercapacitor with 1.0 M Na₂SO₄, LSG/Fe₃O₄ supercapacitor with about 0.025 M [Fe(CN)₆³⁻/Fe(CN)₆⁴⁻] in about 1.0 M Na₂SO₄ and an LSG/Fe₃O₄ micro-supercapacitor with about 0.025 M [Fe(CN)₆³⁻/Fe(CN)₆⁴⁻] in about 1.0 M Na₂SO₄, normalized by the two electrode active materials (LSG/Fe₃O₄) and about 0.025 M RE. The volume is calculated based on the whole device (current collector, active materials, electrolyte, and separator) with no packaging.

TABLE 2

| | Capacitance | | | Energy density | | Power density | |
|---|---|---|---|---|---|---|---|
| | (20 mV s⁻¹) | | | (20 mV s⁻¹) | | (300 mV s⁻¹) | |
| Device | F g⁻¹ | mF cm⁻² | F cm⁻³ | Wh kg⁻¹ | Wh cm⁻³ | kW kg⁻¹ | W cm⁻³ |
| LSG/Fe₃O₄ | 114 | 87.2 | 12.0 | 72.5 | 0.00765 | 39.6 | 4.18 |
| Redox- | 178.9 | 186.1 | 25.6 | 121.5 | 0.0174 | 55.9 | 8.03 |
| electrolyte | | | | | | | |
| LSG/Fe₃O₄ | | | | | | | |
| Redox- | 151.9 | 62.7 | 26.3 | 37.3 | 0.0164 | 11.1 | 4.83 |
| electrolyte | | | | | | | |
| LSG/Fe₃O₄ | | | | | | | |
| Micro- | | | | | | | |
| supercap | | | | | | | |

Performance of LSG/Fe₃O₄ Based Supercapacitors Compared with Reported Supercapacitors

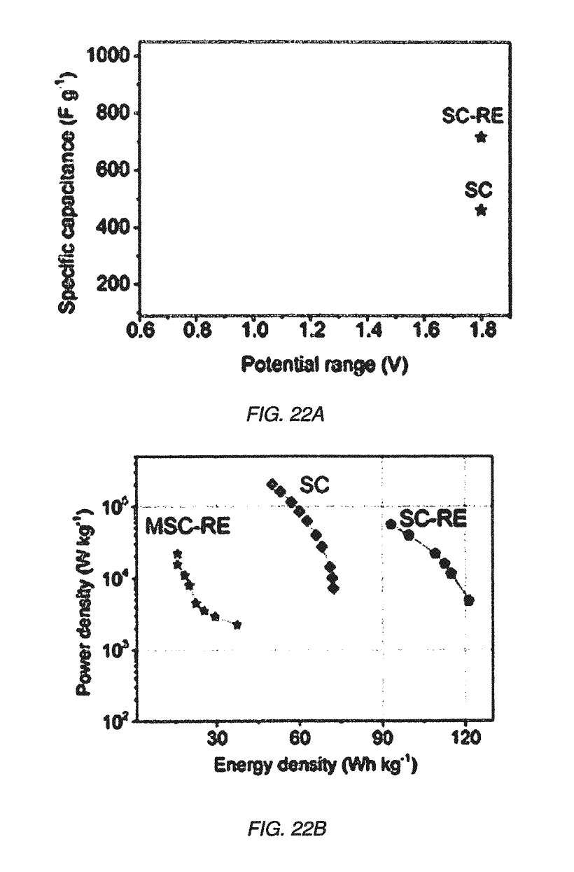

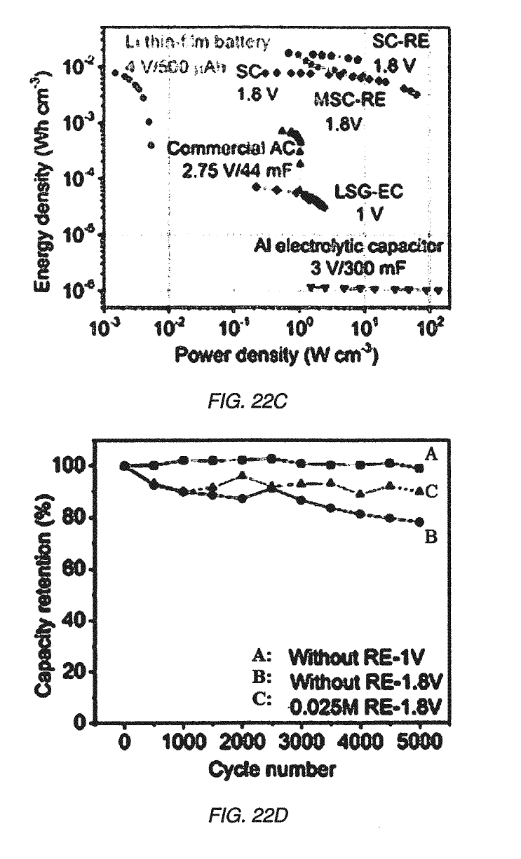

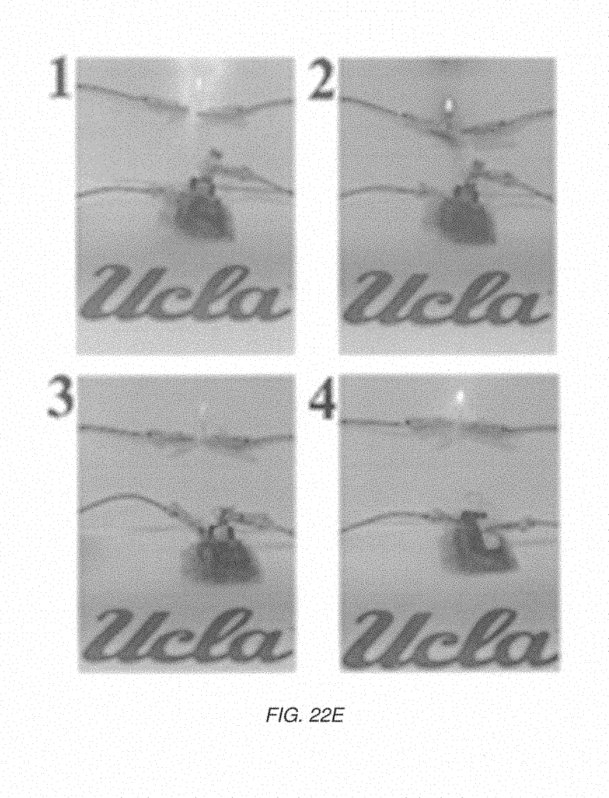

Per FIG. 22A, the exemplary LSG/Fe₃O₄ symmetric supercapacitor provided herein is the only currently available iron oxide supercapacitor that works at about 1.8 V in an aqueous electrolyte. The exemplary LSG/Fe₃O₄ supercapacitor-redox electrolyte (SC-RE) device is capable of delivering a specific capacitance of up to about 716 F g⁻¹, which is approximately 1.5 times higher than that of the traditional 1.0 M Na₂SO₄ electrolyte LSG/Fe₃O₄ supercapacitor cell device. As such, LSG/Fe₃O₄ electrode with a redox active electrolyte herein provides dramatically improved operational voltage and capacitance.

A Ragone plot describing the relationship between the energy density and power density, based on the total mass of the active materials in each device of the exemplary LSG/Fe₃O₄ electrochemical capacitors, is presented in FIG. 22B. As seen, the exemplary SC-RE device is capable of delivering energy densities up to about 121 Wh kg⁻¹. Further, even at a very high power density of about 55.9 kW kg⁻¹, the SC-RE exhibits an energy density of about 93.2 Wh kg⁻¹. The maximum power density of this supercapacitor is about 201 kW kg⁻¹, which is two-orders of magnitude higher than previously published iron oxide hybrid supercapacitors. The mass of the ferrocyanide redox mediator was included in all calculations.

FIG. 22C shows a Ragone plot based on the volume of the full device that includes the active material, current collector, separator, and electrolyte and that compares the LSG/Fe₃O₄ supercapacitors with a commercially available lithium thin film battery, a carbon-based supercapacitor, an aluminum electrolytic capacitor, traditional sandwich-type supercapacitors, and interdigitated micro-supercapacitors. The energy density of the exemplary SC-RE herein is about 17.4 mWh cm⁻³, which is about 15 times higher than any commercially available activated carbon electrochemical capacitor and about 1.5 times higher than a lithium thin film battery. Furthermore, the exemplary SC-RE herein is configured to provide power densities up to about 63 W cm⁻³, which is 10,000 times faster than a lithium thin-film battery. Therefore, LSG/Fe₃O₄ devices in combination with a redox electrolyte could be excellent candidates for future energy storage devices.

A long cycle life is another important characteristic for practical energy storage devices. The combination of a redox-electrolyte and LSG/Fe₃O₄ not only increases the capacitance but also stabilizes the device cycle life at a high operating voltage. FIG. 22D shows the cycle performance of an exemplary symmetric LSG/Fe₃O₄ supercapacitor with and without redox electrolyte that is charged and discharged at a current density of about 12 mA cm⁻² for about 5,000 cycles. The exemplary symmetric LSG/Fe₃O₄ supercapacitor can operate at about 1.8 V in aqueous 1.0 M Na₂SO₄ electrolyte but exhibits a greater cycle life at about 1 V due to electrolyte decomposition forming gas (H₂ or O₂), which detaches the active material from the current collector. The addition of about 0.025 M of the RE into about 1.0 M Na₂SO₄ improves the cycle life to about 90% capacity retention for about 5,000 cycles. In SC-RE device, the ferrocyanide redox mediator may play a major role during charge and discharge.

Without the redox mediator, the positive and negative electrodes may not be charge balanced, meaning that the negative electrode may experience more degradation in cycling stability than the positive electrode, resulting in a supercapacitor with low cycling stability. However, after the redox mediator is added into the electrolyte, the positive and negative electrodes are balanced and a better cycle life is expected.

Supercapacitors are often packed in series to build up modules with operating voltages sufficient for the application. FIG. 22E shows that an exemplary two LSG/Fe₃O₄ electrode supercapacitor in series, when charged for about 3 minutes at about 3.6 V, can brightly light up several LEDs of different colors for about 1 hour: green, 5 mm, 2.6 V, 20 mA; blue, 5 mm, 3.4 V, 20 mA; red, 5 mm, 1.9 V, 20 mA; and white, 5 mm, 3.6 V, 20 mA. These results demonstrate the potential of the LSG/Fe₃O₄ supercapacitors for practical applications.

### Effective Thickness of Supercapacitors and Micro-Supercapacitors

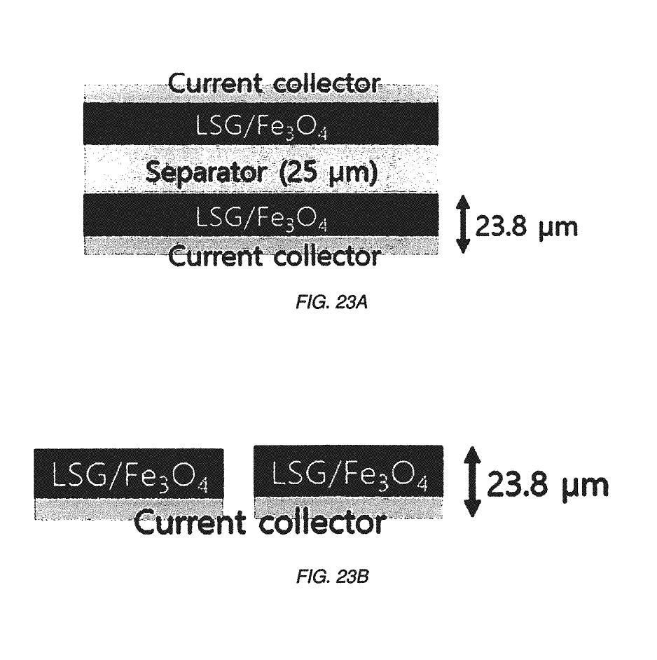

FIGS. 23A and 23B provide schematic illustrations of the cross-section of an exemplary LSG/Fe₃O₄ sandwich-type supercapacitors and interdigitated micro-supercapacitors. As seen, the effective thickness of the sandwich-type device is about 72.6 μm compared with only about 23.8 μm for the planar device.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosures described herein may be employed in practicing the disclosure. It is intended that the following claims define the scope of the disclosure and that methods and structures within the scope of these claims and their equivalents be covered thereby.

### EXAMPLES

### Example 1: Synthesis of LSG/Fe₃O₄ Electrodes

In an exemplary method of synthesis/fabrication, GO was synthesized from graphite flakes using a modified Hummers' method. About 100 mg of FeCl₃.6H₂O in a powder form was slowly added to about 20 mL of a GO dispersion in water (about 2 mg ml⁻¹) under continuous stirring followed by sonication for about 30 minutes. The homogeneous solution was drop-cast onto a gold-sputtered polyimide sheet and dried for about 12 hours under ambient conditions. The dried film was exposed to a 7 W CO₂ laser (Full Spectrum Laser H-series) to synthesize the LSG/Fe₃O₄ film. After being exposed to the laser, the LSG/Fe₃O₄ film was washed with deionized water and directly used as a supercapacitor electrode. To make the micro-structured electrode, the active material (LSG/Fe₃O₄) and the current collector were cut out of a six interdigitated electrode pattern using a 24-W CO₂ laser (Full Spectrum Laser H-series).

### Example 2: Synthesis of LSG/Fe₃O₄ Electrodes

An LSG/Fe₃O₄ electrode was fabricated by the in situ reduction of GO and oxidation of FeCl₃. A GO slurry and FeCl₃ particles were well dispersed in water. Due to the electrostatic effect, Fe³⁺ absorbed on the negatively charged part of the hydrophilic oxygen functional groups of GO. After about 30 minutes of sonication, GO-wrapped Fe³⁺ cation particles were obtained. Following the CO₂ laser etching, the mixed sample underwent a simultaneous oxidation of Fe³⁺ (FeCl₃) to Fe₃O₄ and reduction of GO to LSG, and LSG-wrapped Fe₃O₄ was successfully synthesized.

### Example 2: Fabrication of an LSG/Fe₃O₄ Supercapacitor and Micro-Supercapacitor

The electrodes were extended by connecting copper tape and gold-sputtered polyimide as the current collector. These extended electrodes were connected to a Biologic VMP3 workstation for electrochemical characterization. Polyimide tape was used to insulate the copper tape from exposure to the electrolyte. A symmetric LSG/Fe₃O₄ supercapacitor was constructed from two pieces of LSG/Fe₃O₄ electrodes, separated by an ion-porous membrane, such as polypropylene. These two electrodes and separator were then assembled using polyimide tape after the electrolyte was added. In addition, the symmetric micro-supercapacitor electrodes were extended with copper tape along the edges to improve the connection between the electrodes and the workstation. Polyimide tape was used to cover the copper tape and define the micro-supercapacitor area. An electrolyte was coated onto the active area of the micro-supercapacitor.

### Example 3: Assembly of all-Solid-State Supercapacitors

A gel electrolyte was fabricated by mixing equal amounts of Na₂SO₄ (e.g., about 1 g) and polyvinyl alcohol (e.g., about 1 g) in deionized water (about 10 mL) and then stirring for about 1 hour at about 80° C. The resulting gel electrolyte was applied to the electrodes and left for about 60 minutes in order to ensure complete wetting of the electrode surfaces. The two electrolyte-filled electrodes were assembled and dried for about 12 hours at room temperature until fully solidified.

### Example 4: Materials Characterization and Electrochemical Measurements

Scanning electron microscopy characterization of the LSG/Fe₃O₄ was performed using a Nova 600 SEM/FIB device. The mass of the active material was measured by a Mettler Toledo MX5 microbalance, which was found to be about 382.4 micrograms per square centimeter (μg cm⁻²). The effective thickness of the LSG/Fe₃O₄ hybrid capacitor was about 72.6 μm, including the active material, substrate (about 23.8 μm), and separator (about 25 μm). The TEM images and selected electron area diffraction patterns were collected on a Tecnai G2 TF20 TEM (FEI Inc.) operated at about 200 kV. The high-resolution TEM and selected electron area diffraction data were analyzed using EMMENU4 and ImageJ software. Thermo-gravimetric analysis and DTA were carried out on a Perkin Elmer Diamond Pyris TGA at a heating rate of about 10° C. min⁻¹ in air. X-ray diffraction spectra were recorded on a Panalytical X'Pert Pro X-ray powder diffractometer using Cu Kα radiation with a wavelength of about 0.154 nm. The electrochemical performances of the LSG/Fe₃O₄ electrodes were characterized by CV, galvanostatic CC, and electrochemical impedance spectroscopy (EIS) measurements with various electrolytes. The LSG/Fe₃O₄ electrode tests were carried out using three-electrode cells, with a platinum plate (Aldrich) as the counter-electrode and Ag/AgCl as the reference electrode. The LSG/Fe₃O₄ symmetric capacitors and micro-supercapacitors (two-electrode cells) were characterized using CV, CC, and EIS experiments. The EIS measurements were performed at open circuit potential with a sinusoidal signal over a frequency range from 1 MHz to 10 mHz and an amplitude of 10 mV. All electrochemical data were collected using a Biologic VMP3 electrochemical workstation equipped with a 10-A current booster (VMP3b-10, USA Science Instrument).

### Terms and Definitions

Unless otherwise defined, all technical terms used herein have the same meaning as commonly understood by one of ordinary skill in the art to which the device described herein belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, and unless otherwise specified, the term “about” or “approximately” means an acceptable error for a particular value as determined by one of ordinary skill in the art, which depends in part on how the value is measured or determined. In certain embodiments, the term “about” or “approximately” means within 30%, 25%, 20%, 15%, 10%, 9%, 8%, 7%, 6%, 5%, 4%, 3%, 2%, 1%, 0.5%, 0.1%, or 0.05% of a given value or range. In certain embodiments, the term “about” or “approximately” when used in relation to a percentage means within 30%, 25%, 20%, 15%, 10%, 9%, 8%, 7%, 6%, 5%, 4%, 3%, 2%, 1%, 0.5%, 0.1%, or 0.05% of a given percentage or range of percentages.

What is claimed is:

1. An energy storage device comprising:
a) two or more electrodes, wherein at least one electrode comprises a carbonaceous material and a faradaic material; and
b) an oxidation-reduction (redox)-active electrolyte.

2. The energy storage device of claim 1, wherein the carbonaceous material comprises an interconnected corrugated carbon-based network.

3. The energy storage device of claim 1, wherein the carbonaceous material comprises laser-scribed graphene.

4. The energy storage device of claim 1, wherein the faradaic material comprises metallic nanoparticles.

5. The energy storage device of claim 4, wherein the metallic nanoparticles comprise metal oxide particles.

6. The energy storage device of claim 5, wherein the metal oxide particles comprise magnetite (Fe₃O₄), iron oxide (Fe₂O₃), cobalt oxide (CO₃O₄), nickel hydroxide (Ni(OH)₂), copper oxide (CuO), molybdenum trioxide (MoO₃), vanadium pentoxide (V₂O₅), or any combination thereof.

7. The energy storage device of claim 5, wherein the metal oxide particles comprise magnetite (Fe₃O₄).

8. The energy storage device of claim 1, wherein the redox-active electrolyte comprises fluorine, manganese, chlorine, chromium, oxygen, silver, iron, iodine, copper, tin, quinone, bromine, iodine, vanadium, or combinations thereof.

9. The energy storage device of claim 1, wherein the redox-active electrolyte comprises potassium ferrocyanide, hydroquinone, vanadyl sulfate, p-phenylenediamine, p-phenylenediimine, potassium iodide, potassium bromide, copper chloride, hydroquinone, copper sulfate, heptylviologen dibromide, methyl viologen bromide, or any combination thereof.

10. The energy storage device of claim 1, wherein the redox-active electrolyte comprises ferric cations.

11. The energy storage device of claim 1, wherein the redox-active electrolyte comprises Fe(CN)₆³⁻/Fe(CN)₆⁴⁻.

12. The energy storage device of claim 1, wherein the redox-active electrolyte comprises an aqueous solution.

13. The energy storage device of claim 12, wherein the aqueous solution comprises sulfate ions.

14. The energy storage device of claim 12, wherein the aqueous solution comprises sodium ions.

15. The energy storage device of claim 12, wherein the aqueous solution comprises Na₂SO₄.

16. The energy storage device of claim 1, wherein the redox-active electrolyte comprises Fe(CN)₆³⁻/Fe(CN)₆⁴⁻ and Na₂SO₄.

17. The energy storage device of claim 1, wherein the carbonaceous material comprises laser-scribed graphene, wherein the faradaic material comprises magnetite (Fe₃O₄); and wherein the redox-active electrolyte comprises Fe(CN)₆³⁻/Fe(CN)₆⁴⁻ and Na₂SO₄.

18. The energy storage device of claim 1, wherein the at least one electrode comprises a magnetite (Fe₃O₄) content of about 20% to about 80%.

19. The energy storage device of claim 1, wherein the at least one electrode possesses a magnetic moment.

20. The energy storage device of claim 1, wherein the energy storage device has an operational voltage of about 0.9 V to about 3 V.

21. The energy storage device of claim 1, wherein the energy storage device has a specific capacitance of from about 150 F/g to about 1,400 F/g.

22. The energy storage device of claim 1, wherein the energy storage device has an energy density of from about 45 Wh/kg to about 250 Wh/kg.

23. The energy storage device of claim 1, wherein the energy storage device has a power density of about 45 W/kg to about 180 W/kg.

24. The energy storage device of claim 1, wherein the energy storage device is a battery, a capacitor, a supercapacitor, and/or a micro-supercapacitor.

25. An electrode comprising:
a carbonaceous material; and
metallic nanoparticles.

26. The electrode of claim 25, wherein the carbonaceous material comprises an interconnected corrugated carbon-based network, laser-scribed graphene, or any combination thereof.

27. The electrode of claim 25, wherein the metallic nanoparticles comprise magnetite (Fe₃O₄), iron oxide (Fe₂O₃), cobalt oxide (CO₃O₄), nickel hydroxide (Ni(OH)₂), copper oxide (CuO), molybdenum trioxide (MoO₃), vanadium pentoxide (V₂O₅), or any combination thereof.

28. The electrode of claim 25, wherein the carbonaceous material comprises laser-scribed graphene and the metallic nanoparticles comprise magnetite (Fe₃O₄).

29. The electrode of claim 28, wherein the electrode comprises a magnetite (Fe₃O₄) content of from about 40% to about 85%.

30. A method of fabricating an electrode comprising:
a) sonicating a solution comprising a carbon-based oxide and a metallic salt;
b) disposing the solution comprising a carbon-based oxide and a metallic salt onto a substrate;
c) drying the substrate to create a dried film comprising a carbon-based oxide and a metallic salt; and
d) exposing a portion of the dried film to light to reduce the carbon-based oxide and oxidize the metallic salt.

31. The method of claim 30, wherein the carbon-based oxide comprises graphene oxide.

32. The method of claim 30, wherein the metallic salt comprises iron (Fe).

33. The method of claim 32, wherein the metallic salt comprises iron chloride (FeCl₃).
